(19) United States
(12) Patent Application Publication
(10) Pub. No.: US 2026/0162600 A1
(43) Pub. Date: Jun. 11, 2026

(54) Pixel Driving Circuit, Driving Method therefor, and Display Apparatus

(71) Applicants: Hefei BOE Joint Technology Co.,Ltd., Hefei, Anhui (CN); BOE Technology Group Co., Ltd., Beijing (CN); Beijing BOE Technology Development Co., Ltd., Beijing (CN)

(72) Inventors: Xuehuan FENG, Beijing (CN); Yongqian LI, Beijing (CN)

(21) Appl. No.: 18/704,077

(22) PCT Filed: Aug. 17, 2023
(86) PCT No.: PCT/CN2023/113514

§ 371 Date: Apr. 24, 2024

(51) Int. Cl. G09G 3/3233; G09G 3/32

(52) U.S. Cl. CPC G09G 3/3233; G09G 3/32; G09G 2300/043; G09G 2300/0819; G09G 2300/0852; G09G 2310/08; G09G 2320/0233; G09G 2320/045

(57) ABSTRACT

A pixel driving circuit, a driving method therefor, and a display apparatus are disclosed. The pixel driving circuit includes a driving sub-circuit, a first control sub-circuit, a second control sub-circuit, a third control sub-circuit and a storage sub-circuit, the third control sub-circuit is electrically connected with a first reset signal line (Reset1), an auxiliary signal line (VX) and a third node (N3), respectively, and is configured to control a signal of the third node (N3) under control of a signal of the first reset signal line (Reset1) and under drive of a signal of the auxiliary signal line (VX); the storage sub-circuit is configured to store the voltage difference of signals between a first node (N1) and a third node (N3).

### CROSS-REFERENCE TO RELATED APPLICATION

The present application is a U.S. National Phase Entry of International Application No. PCT/CN2023/113514 having an international filing date of Aug. 17, 2023. The above-identified application is hereby incorporated by reference.

### TECHNICAL FIELD

The present disclosure relates to, but is not limited to, the field of display technology, and in particular to a pixel driving circuit, a driving method therefor and a display apparatus.

### BACKGROUND

An Organic Light Emitting Diode (OLED for short) and a Quantum dot Light Emitting Diode (QLED for short) are active light emitting display devices and have advantages such as self-luminescence, wide viewing angle, high contrast ratio, low power consumption, very high response speed, lightness and thinness, flexibility, and low cost. With constant development of display technologies, a flexible display apparatus (Flexible Display) in which an OLED or a QLED is used as a light emitting device and signal control is performed through a Thin Film Transistor (TFT) has become a mainstream product in the field of display at present.

### SUMMARY

The following is a summary of the subject matter described in detail in the present application. The summary is not intended to limit the scope of protection of the claims.

In a first aspect, the present disclosure provides a pixel driving circuit including: a driving sub-circuit, a first control sub-circuit, a second control sub-circuit, a third control sub-circuit, and a storage sub-circuit; The driving sub-circuit is electrically connected with a first node, a second node, and a third node respectively, and is configured to provide driving current for the third node under control of signals of the first node and the second node; The first control sub-circuit is electrically connected with a first scan signal line, a second scan signal line, a data signal line, a reference signal line and the first node, respectively, and is configured to provide a signal of the data signal line or the reference signal line to the first node under control of signals of the first scan signal line and the second scan signal line; The second control sub-circuit is electrically connected with a first light emitting signal line, a second light emitting signal line, a first power supply line, the second node, the third node and a fourth node, respectively, and is configured to provide a signal of the first power supply line to the second node and a signal of the third node to the fourth node under control of signals of the first light emitting signal line and the second light emitting signal line; The third control sub-circuit is electrically connected with a first reset signal line, an auxiliary signal line and the third node, respectively, and is configured to control the signal of the third node under control of a signal of the first reset signal line and under drive of a signal of the auxiliary signal line; The storage sub-circuit is electrically connected with the first node and the third node, respectively, is configured to store the voltage difference of signals between the first node and the third node.

In an exemplary embodiment, the third control sub-circuit includes: a sixth transistor and a second capacitor; A control electrode of the sixth transistor is electrically connected with the first reset signal line, a first electrode of the sixth transistor is electrically connected with the auxiliary signal line, and a second electrode of the sixth transistor is electrically connected with a fifth node; A first terminal of the second capacitor is electrically connected with the fifth node, and a second terminal of the second capacitor is electrically connected with the third node.

In an exemplary embodiment, the third control sub-circuit is further electrically connected with a third reset signal line and an initial signal line, respectively, and is configured to provide a signal of the initial signal line to the fourth node under control of a signal of the third reset signal line.

In an exemplary embodiment, the third control sub-circuit further includes: an eighth transistor, a control electrode of the eighth transistor is electrically connected with the third reset signal line, a first electrode of the eighth transistor is electrically connected with the initial signal line, and a second electrode of the eighth transistor is electrically connected with the fourth node.

The signal of the auxiliary signal line is a non-DC signal and is electrically connected with the fourth node.

In an exemplary embodiment, the third control sub-circuit is further electrically connected with a second reset signal line, is further configured to provide a signal of a fifth node to the third node under control of a signal of the second reset signal line.

In an exemplary embodiment, the third control sub-circuit includes: a sixth transistor, a seventh transistor, and a second capacitor; A control electrode of the sixth transistor is electrically connected with the first reset signal line, a first electrode of the sixth transistor is electrically connected with the auxiliary signal line, and a second electrode of the sixth transistor is electrically connected with the fifth node; A control electrode of the seventh transistor is electrically connected with the second reset signal line, a first electrode of the seventh transistor is electrically connected with the fifth node, and a second electrode of the seventh transistor is electrically connected with the third node; A first terminal of the second capacitor is electrically connected with the fifth node, and a second terminal of the second capacitor is electrically connected with the third node.

In an exemplary embodiment, the signal of the auxiliary signal line is a DC signal and is the same as the signal of any one of the initial signal line, the reference signal line and the first power supply line.

In an exemplary embodiment, the third control sub-circuit includes: a sixth transistor and a second capacitor; A first terminal of the second capacitor is electrically connected with the auxiliary signal line, and a second terminal of the second capacitor is electrically connected with the fifth node; A control electrode of the sixth transistor is electrically connected with the first reset signal line, a first electrode of the sixth transistor is electrically connected with the fifth node, and a second electrode of the sixth transistor is electrically connected with the third node.

In an exemplary embodiment, the third control sub-circuit is further electrically connected with the third reset signal line and the initial signal line, respectively, and is configured to provide a signal of the initial signal line to the fourth node under control of a signal of the third reset signal line.

In an exemplary embodiment, the third control sub-circuit further includes: an eighth transistor, a control electrode of the eighth transistor is electrically connected with the third reset signal line, a first electrode of the eighth transistor is electrically connected with the initial signal line, and a second electrode of the eighth transistor is electrically connected with the fourth node; A signal of the auxiliary signal line is a DC signal, and the signal of the auxiliary signal line is the same as the signal of any one of the initial signal line, the reference signal line and the first power supply line; Alternatively, the signal of the auxiliary signal line is a non-DC signal, and the signal of the auxiliary signal line is electrically connected with the fourth node.

In an exemplary embodiment, the first control sub-circuit includes: a first transistor and a second transistor, the driving sub-circuit includes: a third transistor, the second control sub-circuit includes: a fourth transistor and a fifth transistor, and the storage sub-circuit includes: a first capacitor; A control electrode of the first transistor is electrically connected with the first scan signal line, a first electrode of the first transistor is electrically connected with the data signal line, and a second electrode of the first transistor is electrically connected with the first node; A control electrode of the second transistor is electrically connected with the second scan signal line, a first electrode of the second transistor is electrically connected with the reference signal line, and a second electrode of the second transistor is electrically connected with the first node; A control electrode of the third transistor is electrically connected with the first node, a first electrode of the third transistor is electrically connected with the second node, and a second electrode of the third transistor is electrically connected with the third node; A control electrode of the fourth transistor is electrically connected with the first light emitting signal line, a first electrode of the fourth transistor is electrically connected with the first power supply line, and a second electrode of the fourth transistor is electrically connected with the second node; A control electrode of the fifth transistor is electrically connected with the second light emitting signal line, a first electrode of the fifth transistor is electrically connected with the third node, and a second electrode of the fifth transistor is electrically connected with the fourth node; A first terminal of the first capacitor is electrically connected with the first node, and a second terminal of the first capacitor is electrically connected with the third node.

In an exemplary embodiment, the first control sub-circuit includes: a first transistor and a second transistor, the driving sub-circuit includes: a third transistor, the second control sub-circuit includes: a fourth transistor and a fifth transistor, the storage sub-circuit includes: a first capacitor, the third control sub-circuit includes a second capacitor and a sixth transistor, and the third control sub-circuit further includes: at least one of a seventh transistor and an eighth transistor; A control electrode of the first transistor is electrically connected with the first scan signal line, a first electrode of the first transistor is electrically connected with the data signal line, and a second electrode of the first transistor is electrically connected with the first node; A control electrode of the second transistor is electrically connected with the second scan signal line, a first electrode of the second transistor is electrically connected with the reference signal line, and a second electrode of the second transistor is electrically connected with the first node; A control electrode of the third transistor is electrically connected with the first node, a first electrode of the third transistor is electrically connected with the second node, and a second electrode of the third transistor is electrically connected with the third node; A control electrode of the fourth transistor is electrically connected with the first light emitting signal line, a first electrode of the fourth transistor is electrically connected with the first power supply line, and a second electrode of the fourth transistor is electrically connected with the second node; A control electrode of the fifth transistor is electrically connected with the second light emitting signal line, a first electrode of the fifth transistor is electrically connected with the third node, and a second electrode of the fifth transistor is electrically connected with the fourth node; A control electrode of the sixth transistor is electrically connected with the first reset signal line, a first electrode of the sixth transistor is electrically connected with the auxiliary signal line, and a second electrode of the sixth transistor is electrically connected with the fifth node; A control electrode of the seventh transistor is electrically connected with the second reset signal line, a first electrode of the seventh transistor is electrically connected with the fifth node, and a second electrode of the seventh transistor is electrically connected with the third node; A control electrode of the eighth transistor is electrically connected with the third reset signal line, a first electrode of the eighth transistor is electrically connected with the initial signal line, and a second electrode of the eighth transistor is electrically connected with the fourth node; A first terminal of the first capacitor is electrically connected with the first node, and a second terminal of the first capacitor is electrically connected with the third node; A first terminal of the second capacitor is electrically connected with the fifth node, and a second terminal of the second capacitor is electrically connected with the third node; Any one of the first transistor to the eighth transistor is an N-type transistor.

In an exemplary embodiment, the third control sub-circuit includes a sixth transistor, a seventh transistor, and a second capacitor, signals of the second reset signal line and the second light emitting signal line are effective level signals for part of a time period in which a signal of the first reset signal line is an effective level signal, and the signal of the second reset signal line is an effective level signal for at least part of a time period after a writing time period, said writing time period is a time period in which the first scan signal line is an effective level signal.

In an exemplary embodiment, the third control sub-circuit includes a sixth transistor, an eighth transistor, and a second capacitor, A signal of the second light emitting signal line is an effective level signal for part of a time period in which a signal of the third reset signal line is an effective level signal, and signals of the first reset signal line and the second light emitting signal line are effective level signals for at least part of a time period following a writing time period, the writing time period is a time period in which the first scan signal line is an effective level signal.

In an exemplary embodiment, the third control sub-circuit includes a sixth transistor, a seventh transistor, an eighth transistor, and a second capacitor, when a signal of the first reset signal line is an effective level signal, a signal of the third reset signal line is an effective level signal, and a signal of the second reset signal line is an ineffective level signal, when the signal of the second reset signal line is an effective level signal, the signal of the first reset signal line is an ineffective level signal, a signal of the second light emitting signal line is an effective level signal for part of a time period in which a signal of the third reset signal line is an effective level signal, and the signal of the second reset signal line is an effective level signal for at least part of a time period after a writing time period, the writing time period is a time period in which the first scanning signal line is an effective level signal.

In an exemplary embodiment, the first control sub-circuit includes: a first transistor and a second transistor, the driving sub-circuit includes: a third transistor, the second control sub-circuit includes: a fourth transistor and a fifth transistor, and the storage sub-circuit includes: a first capacitor, the third control sub-circuit includes: a second capacitor, a sixth transistor, and an eighth transistor; A control electrode of the first transistor is electrically connected with the first scan signal line, a first electrode of the first transistor is electrically connected with the data signal line, and a second electrode of the first transistor is electrically connected with the first node; A control electrode of the second transistor is electrically connected with the second scan signal line, a first electrode of the second transistor is electrically connected with the reference signal line, and a second electrode of the second transistor is electrically connected with the first node; A control electrode of the third transistor is electrically connected with the first node, a first electrode of the third transistor is electrically connected with the second node, and a second electrode of the third transistor is electrically connected with the third node; A control electrode of the fourth transistor is electrically connected with the first light emitting signal line, a first electrode of the fourth transistor is electrically connected with the first power supply line, and a second electrode of the fourth transistor is electrically connected with the second node; A control electrode of the fifth transistor is electrically connected with the second light emitting signal line, a first electrode of the fifth transistor is electrically connected with the third node, and a second electrode of the fifth transistor is electrically connected with the fourth node; A control electrode of the sixth transistor is electrically connected with the first reset signal line, a first electrode of the sixth transistor is electrically connected with the fifth node, and a second electrode of the sixth transistor is electrically connected with the third node; A control electrode of the eighth transistor is electrically connected with the third reset signal line, a first electrode of the eighth transistor is electrically connected with the initial signal line, and a second electrode of the eighth transistor is electrically connected with the fourth node; A first terminal of the first capacitor is electrically connected with the first node, and a second terminal of the first capacitor is electrically connected with the third node; A first terminal of the second capacitor is electrically connected with the auxiliary signal line, and a second terminal of the second capacitor is electrically connected with the fifth node; Any one of the first transistor, the second transistor, the fourth transistor, the fifth transistor, the sixth transistor, and the eighth transistor is an N-type transistor.

In an exemplary embodiment, a signal of the second light emitting signal line is an effective level signal for part of a time period in which a signal of the third reset signal line is an effective level signal, and a signal of the first reset signal line is an ineffective level signal for a time period following a writing time period, the writing time period is a time period in which the first scanning signal line is an effective level signal.

In a second aspect, the present disclosure further provides a display apparatus with a display region provided with a plurality of above-described pixel driving circuits.

In a third aspect, the present disclosure further provides a driving method of a pixel driving circuit configured to drive the above-described pixel driving circuit, the method including: The driving sub-circuit provides driving current to the third node under control of signals of the first node and the second node; The first control sub-circuit provides a signal of the data signal line or the reference signal line to the first node under control of signals of the first scan signal line and the second scan signal line; The second control sub-circuit provides a signal of the first power supply line to the second node and a signal of the third node to the fourth node under control of signals of the first light emitting signal line and the second light emitting signal line; The third control sub-circuit controls the signal of the third node under control of a signal of the first reset signal line and under drive of a signal of the auxiliary signal line; The storage sub-circuit stores the voltage difference of signals between the first node and the third node.

In a fourth aspect, the present disclosure further provides a driving method of a pixel driving circuit configured to drive the above-described pixel driving circuit, a working process of the pixel driving circuit includes a first stage to a fifth stage, the method including: In the first stage, effective level signals are provided to signals of the second scan signal line, the second light emitting signal line, the first reset signal line and the second reset signal line, the first control sub-circuit provides a signal of the reference signal line to the first node, the third control sub-circuit provides a signal of the auxiliary signal line to the fifth node, and provides a signal of the fifth node to the third node, and the second control sub-circuit provides a signal of the fourth node to the third node; In the second stage, effective level signals are provided to the first reset signal line, the second scan signal line and the first light emitting signal line, the first control sub-circuit provides the signal of the reference signal line to the first node, the third control sub-circuit provides the signal of the auxiliary signal line to the fifth node, the second control sub-circuit provides a signal of the first power supply line to the second node to charge the first node, and the storage sub-circuit stores a voltage difference between signals of the first node and the third node; In the third stage, signals to the first reset signal line and the first scan signal line are high-level signals, the first control sub-circuit provides the signal of the data signal line to the first node, and the third control sub-circuit provides the signal of the auxiliary signal line to the fifth node; In the fourth stage, effective level signals are provided to the second reset signal line and the second light emitting signal line, the third control sub-circuit provides a signal of the third node to the fifth node, and the second control sub-circuit provides the signal of the fourth node to the third node; In the fifth stage, effective level signals are provided to the second reset signal line, the first light emitting signal line and the second light emitting signal line, the second control sub-circuit provides the signal of the first power supply line to the second node, the signal of the third node to the fourth node, the driving sub-circuit provides driving current to the third node under control of signals of the first node and the second node, and the third control sub-circuit provides the signal of the third node to the fifth node.

In a fifth aspect, the present disclosure further provides a driving method of a pixel driving circuit configured to drive the above-described pixel driving circuit, a working process of the pixel driving circuit including a first stage to a fifth stage, the method including: In the first stage, effective level signals are provided to signals of the second scan signal line, the second light emitting signal line, the first reset signal line and the third reset signal line, the first control sub-circuit provides a signal of the reference signal line to the first node, the third control sub-circuit provides a signal of the auxiliary signal line to the fifth node, and provides a signal of the initial signal line to the fourth node, and the second control sub-circuit provides a signal of the fourth node to the third node; In the second stage, effective level signals are provided to the first reset signal line, the third reset signal line, the second scan signal line and the first light emitting signal line, the first control sub-circuit provides the signal of the reference signal line to the first node, the third control sub-circuit provides the signal of the auxiliary signal line to the fifth node and a signal of the initial signal line to the fourth node, the second control sub-circuit provides a signal of the first power supply line to the second node to charge the first node, and the storage sub-circuit stores a voltage difference between signals of the first node and the third node; In the third stage, signals to the first reset signal line, the third reset signal line and the first scan signal line are high-level signals, the first control sub-circuit provides the signal of the data signal line to the first node, the third control sub-circuit provides the signal of the auxiliary signal line to the fifth node, and provides the signal of the initial signal line to the fourth node; In the fourth stage, effective level signals are provided to the first reset signal line, the third reset signal line and the second light emitting signal line, the third control sub-circuit provides the signal of the initial signal line to the fourth node, the signal of the auxiliary signal line to the fifth node, and the second control sub-circuit provides the signal of the fourth node to the third node; In the fifth stage, effective level signals are provided to the first reset signal line, the first light emitting signal line and the second light emitting signal line, the second control sub-circuit provides the signal of the first power supply line to the second node, the signal of the third node to the fourth node, the driving sub-circuit provides driving current to the third node under control of signals of the first node and the second node, and the third control sub-circuit provides the signal of the auxiliary signal line to the fifth node.

In a sixth aspect, the present disclosure further provides a driving method of a pixel driving circuit configured to drive the above-described pixel driving circuit, a working process of the pixel driving circuit including a first stage to a fifth stage, the method including:

In the first stage, effective level signals are provided to signals of the second scan signal line, the second light emitting signal line, the first reset signal line and the third reset signal line, the first control sub-circuit provides a signal of the reference signal line to the first node, the third control sub-circuit provides a signal of the auxiliary signal line to the fifth node, and provides a signal of the initial signal line to the fourth node, and the second control sub-circuit provides a signal of the fourth node to the third node.

In the second stage, effective level signals are provided to the first reset signal line, the third reset signal line, the second scan signal line and the first light emitting signal line, the first control sub-circuit provides the signal of the reference signal line to the first node, the third control sub-circuit provides the signal of the auxiliary signal line to the fifth node and the signal of the initial signal line to the fourth node, the second control sub-circuit provides a signal of a first power supply line to the second node to charge the first node, and the storage sub-circuit stores a voltage difference between signals of the first node and the third node.

In the third stage, signals to the first reset signal line, the third reset signal line and the first scan signal line are high-level signals, the first control sub-circuit provides the signal of the data signal line to the first node, the third control sub-circuit provides the signal of the auxiliary signal line to the fifth node, and provides the signal of the initial signal line to the fourth node.

In the fourth stage, effective level signals are provided to the second reset signal line, the third reset signal line and the second light emitting signal line, the third control sub-circuit provides the signal of the initial signal line to the fourth node, the signal of the third node to the fifth node, and the second control sub-circuit provides the signal of the fourth node to the third node.

In the fifth stage, effective level signals are provided to the second reset signal line, the first light emitting signal line and the second light emitting signal line, the second control sub-circuit provides the signal of the first power supply line to the second node, the signal of the third node to the fourth node, the driving sub-circuit provides driving current to the third node under control of signals of the first node and the second node, and the third control sub-circuit provides the signal of the third node to the fifth node.

In a seventh aspect, the present disclosure further provides a driving method of a pixel driving circuit configured to drive the above-described pixel driving circuit, a working process of the pixel driving circuit including a first stage to a fifth stage, the method including:

In the first stage, effective level signals are provided to signals of the second scan signal line, the second light emitting signal line, the first reset signal line and the third reset signal line, the first control sub-circuit provides a signal of the reference signal line to the first node, the third control sub-circuit provides a signal of the third node to the fifth node, and provides a signal of the initial signal line to the fourth node, and the second control sub-circuit provides a signal of the fourth node to the third node.

In the second stage, effective level signals are provided to the first reset signal line, the third reset signal line, the second scan signal line and the first light emitting signal line, the first control sub-circuit provides the signal of the reference signal line to the first node, the third control sub-circuit provides the signal of the third node to the fifth node and the signal of the initial signal line to the fourth node, the second control sub-circuit provides a signal of the first power supply line to the second node to charge the first node, and the storage sub-circuit stores a voltage difference between signals of the first node and the third node.

In the third stage, signals to the first reset signal line, the third reset signal line and the first scan signal line are high-level signals, the first control sub-circuit provides the signal of the data signal line to the first node, the third control sub-circuit provides the signal of the initial signal line to the fourth node, and provides the signal of the third node to the fifth node.

In the fourth stage, effective level signals are provided to the third reset signal line and the second light emitting signal line, the third control sub-circuit provides the signal of the initial signal line to the fourth node, and the second control sub-circuit provides the signal of the fourth node to the third node.

In the fifth stage, effective level signals are provided to the first light emitting signal line and the second light emitting signal line, the second control sub-circuit provides the signal of the first power supply line to the second node, the signal of the third node to the fourth node, and the driving sub-circuit provides driving current to the third node under control of signals of the first node and the second node.

Other aspects of the present disclosure may be comprehended after the drawings and the detailed descriptions are read and understood.

### BRIEF DESCRIPTION OF DRAWINGS

Accompanying drawings are used for providing an understanding for technical solutions of the present application and form a part of the specification, are used for explaining the technical solutions of the present application together with embodiments of the present application, and do not constitute a limitation on the technical solutions of the present application.

FIG. 1 is a schematic diagram of a structure of a pixel driving circuit according to an embodiment of the present disclosure.

FIG. 2 is an equivalent circuit diagram I of a third control sub-circuit;

FIG. 3 is an equivalent circuit diagram II of a third control sub-circuit;

FIG. 4 is an equivalent circuit diagram III of a third control sub-circuit;

FIG. 5 is an equivalent circuit diagram IV of a third control sub-circuit;

FIG. 6 is an equivalent circuit diagram V of a third control sub-circuit;

FIG. 7 is an equivalent circuit diagram VI of a third control sub-circuit;

FIG. 8 is a partial equivalent circuit diagram of a pixel driving circuit;

FIG. 9 is an equivalent circuit diagram I of a pixel driving circuit;

FIG. 10 is an equivalent circuit diagram II of a pixel driving circuit;

FIG. 11 is an equivalent circuit diagram III of a pixel driving circuit;

FIG. 12 is an equivalent circuit diagram IV of a pixel driving circuit;

FIG. 13 is an equivalent circuit diagram V of a pixel driving circuit;

FIG. 14 is an equivalent circuit diagram VI of a pixel driving circuit;

FIG. 15 is a working timing diagram of the pixel driving circuit provided in FIGS. 9 and 10;

FIG. 16 is a working timing diagram of the pixel driving circuit provided in FIG. 11.

FIG. 17 is a working timing diagram of the pixel driving circuit provided in FIG. 12.

FIG. 18 is a working timing diagram of the pixel driving circuit provided in FIGS. 13 and 14.

### DETAILED DESCRIPTION

To make the objectives, technical solutions, and advantages of the present disclosure clearer, the embodiments of the present disclosure will be described in detail below in with reference to the accompany drawings. It is to be noted that the embodiments may be implemented in various forms. Those of ordinary skills in the art can easily understand such a fact that embodiments and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict. In order to keep following description of the embodiments of the present disclosure clear and concise, detailed description of part of known functions and known components are omitted in the present disclosure. The drawings in the embodiments of the present disclosure relate only to the structures involved in the embodiments of the present disclosure, and other structures may be described with reference to conventional designs.

Scales of the drawings in the present disclosure may be used as a reference in actual processes, but are not limited thereto. For example, a width-length ratio of a channel, a thickness and spacing of various film layers, and a width and spacing of various signal lines may be adjusted according to actual needs. A quantity of pixels in a display substrate and a quantity of sub-pixels in each pixel are not limited to numbers shown in the drawings. The drawings described in the present disclosure are schematic structural diagrams only, and one embodiment of the present disclosure is not limited to shapes, numerical values, or the like shown in the drawings.

Ordinal numerals “first”, “second”, “third”, etc., in the specification are set not to form limits in numbers but only to avoid confusion between composition elements.

In the specification, for convenience, expressions “central”, “above”, “below”, “front”, “back”, “vertical”, “horizontal”, “top”, “bottom”, “inside”, “outside”, etc., indicating orientation or positional relationships are used to illustrate positional relationships between the composition elements, not to indicate or imply that involved devices or elements are required to have specific orientations and be structured and operated with the specific orientations but only to easily and simply describe the present specification, and thus should not be understood as limitations on the present disclosure. The positional relationships between the composition elements may be changed as appropriate according to a direction according to which each composition element is described. Therefore, appropriate replacements based on situations are allowed, which is not limited to the expressions in the specification.

In the specification, unless otherwise specified and defined, terms “mounting”, “mutual connection”, and “connection” should be understood in a broad sense. For example, a connection may be fixed connection, or detachable connection, or integral connection; it may be mechanical connection or electrical connection; it may be direct connection, or indirect connection through an intermediate, or internal communication between two elements. Those of ordinary skills in the art can understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, “electrical connection” includes connection of composition elements through an element with a certain electrical action. An “element with a certain electrical action” is not particularly limited as long as electric signals between the connected composition elements may be sent and received. Examples of the “element with the certain electrical action” not only include an electrode and a line, but also include a switch element such as a transistor, a resistor, an inductor, a capacitor, another element with various functions, etc.

In the specification, “disposed in a same layer” refers to a structure formed by patterning two (or more than two) structures through a same patterning process, and their materials may be the same or different. For example, materials of precursors for forming multiple structures disposed in a same layer are the same, and final formed materials may be the same or different.

With development of OLED display technologies, oxide process is often used in OLED display products because of its high uniformity. The coupling effect of some capacitors in the pixel driving circuits made by the oxide process will introduce noise in the display stage, which makes the driving current output by the pixel driving circuit unstable and affects the reliability of the pixel driving circuit.

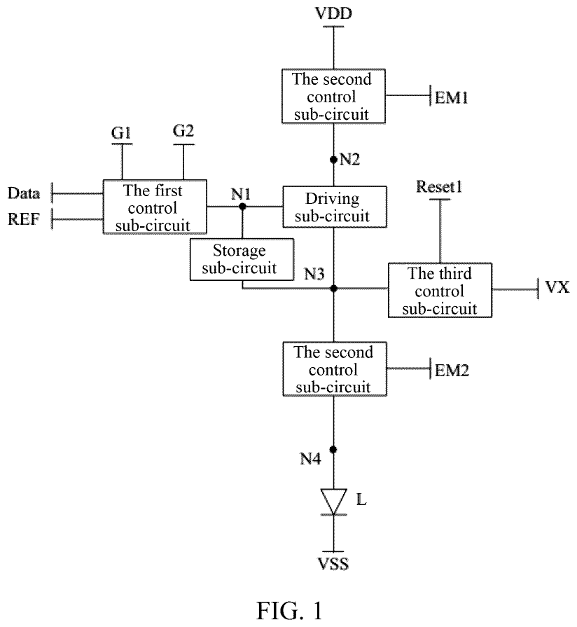

FIG. 1 is a schematic diagram of a structure of a pixel driving circuit according to an embodiment of the present disclosure. As shown in FIG. 1, the pixel driving circuit according to an embodiment of the present disclosure may include a driving sub-circuit, a first control sub-circuit, a second control sub-circuit, a third control sub-circuit, and a storage sub-circuit.

As shown in FIG. 1, the driving sub-circuit is electrically connected to the first node N1, the second node N2, and the third node N3, respectively, is configured to provide driving current to the third node N3 under control of signals of the first node N1 and the second node N2; the first control sub-circuit is electrically connected to a first scan signal line G1, a second scan signal line G2, a data signal line Data, a reference signal line REF and the first node N1, respectively, and configured to provide a signal of the data signal line Data or the reference signal line REF to the first node N1 under control of signals of the first scan signal line G1 and the second scan signal line G2; the second control sub-circuit is electrically connected to a first light emitting signal line EM1, a second light emitting signal line EM2, a first power supply line VDD, the second node N2, the third node N3 and the fourth node N4, respectively, and configured to provide a signal of the first power supply line VDD to the second node N2 and provide a signal of the third node N3 to the fourth node N4 under control of signals of the first light emitting signal line EM1 and the second light emitting signal line EM2; the third control sub-circuit is electrically connected to a first reset signal line Reset1, an auxiliary signal line VX and the third node N3, respectively, and configured to control a signal of the third node N3 under control of a signal of the first reset signal line Reset1 and under drive of a signal of the auxiliary signal line VX; the storage sub-circuit is electrically connected to the first node N1 and the third node N3, respectively, is configured to store the voltage difference of signals between the first node N1 and the third node N3.

In an exemplary embodiment, as shown in FIG. 1, the pixel driving circuit is electrically connected to the light emitting device L through the fourth node N4.

In an exemplary embodiment, the light emitting device L may include a first electrode (anode), an organic emitting layer, and a second electrode (cathode) that are stacked. Exemplarily, the anode of the light emitting device L is electrically connected to the fourth node N4, and the cathode of the light emitting device L is electrically connected to the second power supply line VSS.

In an exemplary embodiment, the light emitting device L, which may include a current-driven device, may use a current-type light emitting diode, such as a micro light emitting diode (Micro LED), or a mini light emitting Diode (Mini LED), or an Organic light emitting diode (OLED), or a quantum light emitting diode (QLED). A typical size (e.g., length) of a Micro-LED may be less than 100 μm, e.g., 10 μm to 50 μm. A typical size (e.g., length) of a Mini-LED may be about 100 μm to 300 μm, e.g., 120 μm to 260 μm.

In an exemplary embodiment, the organic emitting layer may include a Hole Injection Layer (HIL), a Hole Transport Layer (HTL), an Electron Block Layer (EBL), an Emitting Layer (EML), a Hole Block Layer (HBL), an Electron Transport Layer (ETL), and an Electron Injection Layer (EIL) that are stacked. In an exemplary embodiment, hole injection layers of all sub-pixels may be connected together to be a common layer, electron injection layers of all the sub-pixels may be connected together to be a common layer, hole transport layers of all the sub-pixels may be connected together to be a common layer, electron transport layers of all the sub-pixels may be connected together to be a common layer, hole block layers of all the sub-pixels may be connected together to be a common layer, emitting layers of adjacent sub-pixels may be overlapped slightly or may be isolated, and electron block layers of adjacent sub-pixels may be overlapped slightly or may be isolated.

In an exemplary embodiment, the first power supply line VDD continuously provides a high-level signal, and a signal of the first power supply line VDD is a Direct Current (DC) signal.

In an exemplary embodiment, the second power supply line VSS continuously provides a low-level signal, and a signal of the second power supply line VSS is a DC signal.

In an exemplary embodiment, the reference signal line REF continuously provides a low-level signal, a signal of the reference signal line REF is a DC signal, and exemplarily, a voltage of the signal of the reference signal line REF may be 0V.

In an exemplary embodiment, the pixel driving circuit is located in a display substrate, and the content displayed by the display substrate includes a plurality of display frames. In any display frame, a signal of the first scan signal line G1 is a pulse signal, a signal of the second scan signal line G2 is a pulse signal, and the time period in which the second scan signal line G2 is an effective level signal occurs before the time period in which the first scan signal line G1 is an effective level signal.

The embodiment of the present disclosure provides a pixel driving circuit, which comprises a driving sub-circuit, a first control sub-circuit, a second control sub-circuit, a third control sub-circuit and a storage sub-circuit; the driving sub-circuit is electrically connected to a first node, a second node, and a third node, respectively, configured to provide driving current to the third node under control of signals of the first node and the second node; the first control sub-circuit is electrically connected to a first scan signal line, a second scan signal line, a data signal line, a reference signal line and the first node, respectively, and configured to provide a signal of the data signal line or the reference signal line to the first node under control of signals of the first scan signal line and the second scan signal line; the second control sub-circuit is electrically connected to a first light emitting signal line, a second light emitting signal line, a first power supply line, the second node, the third node and the fourth node, respectively, and configured to provide a signal of the first power supply line to the second node and provide a signal of the third node to the fourth node under control of signals of the first light emitting signal line and the second light emitting signal line; the third control sub-circuit is electrically connected to a first reset signal line, an auxiliary signal line and the third node, respectively, and configured to control a signal of the third node under control of a signal of the first reset signal line and under drive of a signal of the auxiliary signal line; the storage sub-circuit is electrically connected to the first node and the third node, respectively, is configured to store the voltage difference of signals between the first node and the third node. The present disclosure can control the signal of the third node through signals of the first reset signal line and the auxiliary signal line by providing the third control sub-circuit, so as to avoid the introduction of noise in the display stage, keep the stability of the driving current output by the pixel driving circuit, and improve the reliability of the pixel driving circuit.

In an exemplary embodiment, a working process of the pixel driving circuit includes a display stage including a writing stage and a light emitting stage, wherein the light emitting stage occurs after the writing stage, and a signal of the first scan signal line G1 is an effective level signal in the writing stage. Signals of the first light emitting signal line EM1 and the second light emitting signal line EM2 are both effective level signals in the light emitting stage, and the time at which the writing stage occurs is a writing time period.

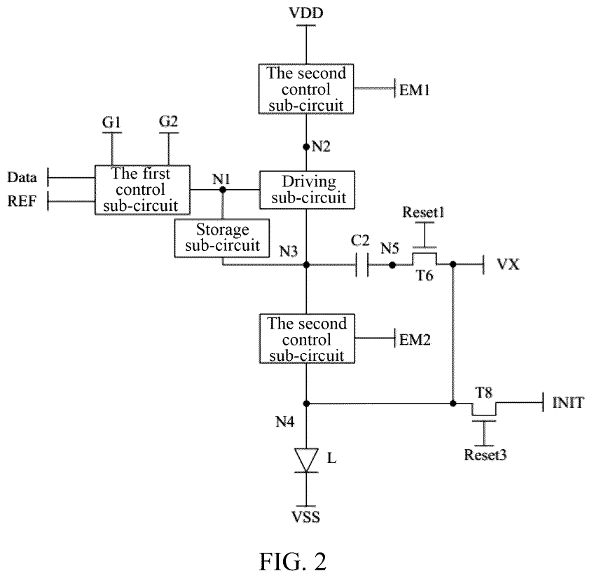

FIG. 2 is an equivalent circuit diagram I of a third control sub-circuit. As shown in FIG. 2, in an exemplary embodiment, the third control sub-circuit may be electrically connected to the third reset signal line Reset3 and the initial signal line INIT, respectively, and configured to provide a signal of the initial signal line to the fourth node N4 under control of a signal of the third reset signal line Reset3. Exemplarily, the third control sub-circuit may include a sixth transistor T6, an eighth transistor T8 and a second capacitor C2. A control electrode of the sixth transistor T6 is electrically connected to the first reset signal line Reset1, a first electrode of the sixth transistor T6 is electrically connected to the auxiliary signal line VX, and a second electrode of the sixth transistor T6 is electrically connected to the fifth node N5; a first terminal of the second capacitor C2 is electrically connected to the fifth node N5, and a second terminal of the second capacitor C2 is electrically connected to the third node N3; a first electrode of the eighth transistor T8 is electrically connected to the initial signal line INIT, and a second electrode of the eighth transistor T8 is electrically connected to the fourth node N4.

In an exemplary embodiment, as shown in FIG. 2, a signal of the auxiliary signal line VX is a non-DC signal and is electrically connected to the fourth node N4.

In an exemplary embodiment, as shown in FIG. 2, the present disclosure, by enabling a signal of the second light emitting signal line EM2 to be an effective level signal during part of a time period in which a signal of the third reset signal line Reset3 is an effective level signal, can reset the third node N3 and the fourth node N4 prior to the writing time period, and can ensure the display uniformity of the pixel driving circuit. The present disclosure, by enabling signals of the first reset signal line Reset1 and the second light emitting signal line EM2 to be effective level signals during at least part of a time period after the writing time period, can make voltage values of signals at two ends of the second capacitor C2 in the light emitting stage the same, avoid the influence of the second capacitor C2 on the third node N3 in the light emitting stage, avoid the introduction of noise in the third node N3, which can keep the stability of the driving current output by the pixel driving circuit, and improve the reliability of the pixel driving circuit.

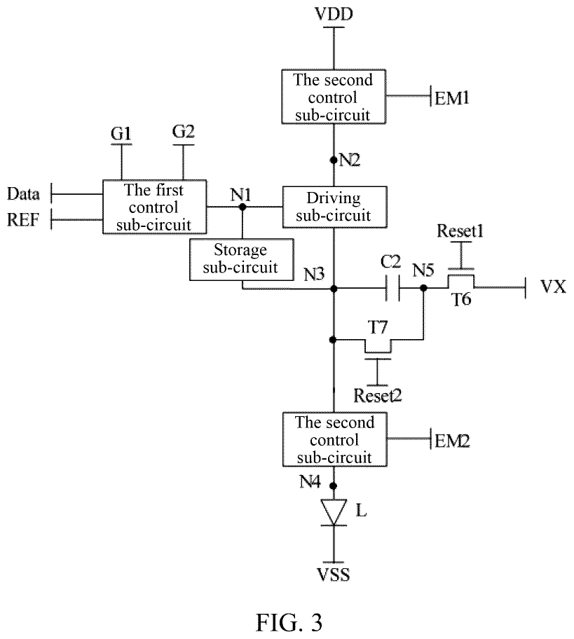

FIG. 3 is an equivalent circuit diagram II of a third control sub-circuit. As shown in FIG. 3, in an exemplary embodiment, the third control sub-circuit may be electrically connected to the second reset signal line Reset2, and is configured to provide a signal of the fifth node N5 to the third node N3 under control of a signal of the second reset signal line Reset2. Exemplarily, the third control sub-circuit may include a sixth transistor T6, a seventh transistor T7 and a second capacitor C2. A first electrode of the sixth transistor T6 is electrically connected to the auxiliary signal line VX, and a second electrode of the sixth transistor T6 is electrically connected to the fifth node N5; a control electrode of the seventh transistor T7 is electrically connected to a second reset signal line Reset3, a first electrode of the seventh transistor T7 is electrically connected to the fifth node N5, and a second electrode of the seventh transistor T7 is electrically connected to the third node N3; a first terminal of the second capacitor C2 is electrically connected to the fifth node N5, and a second terminal of the second capacitor C2 is electrically connected to the third node N3.

In an exemplary embodiment, as shown in FIG. 3, a signal of the auxiliary signal line VX may be a DC signal and is the same as a signal of any one of the initial signal line INIT, the reference signal line REF, and the first power supply line VDD.

In an exemplary embodiment, as shown in FIG. 3, the present disclosure, by enabling signals of the second reset signal line Reset2 and the second light emitting signal line EM2 to be effective level signals during part of a time period in which a signal of the first reset signal line Reset1 is the effective level signal, can reset the third node N3 and the fourth node N4 prior to the writing time period, and can ensure the display uniformity of the pixel driving circuit. The present disclosure, by enabling the second reset signal line Reset2 to be an effective level signal during at least part of a time period after the writing time period, can make voltage values of signals at two ends of the second capacitor C2 in the light emitting stage the same, avoid the influence of the second capacitor C2 on the third node N3 in the light emitting stage, avoid the introduction of noise in the display stage, keep the stability of the driving current output by the pixel driving circuit, and improve the reliability of the pixel driving circuit.

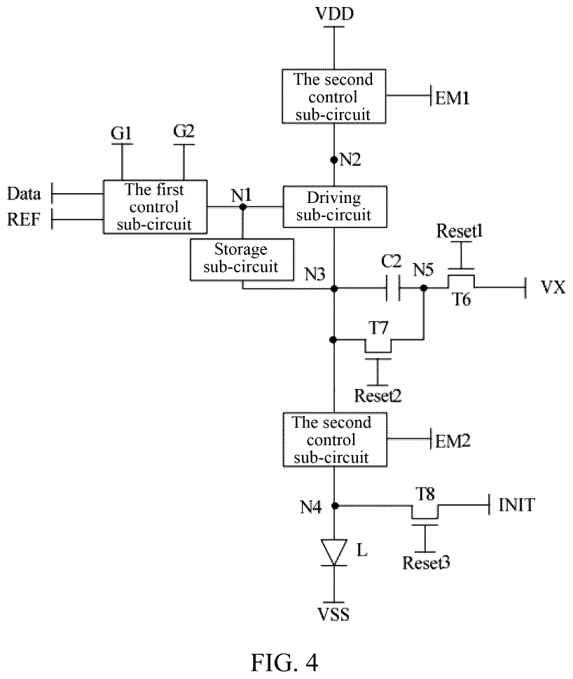

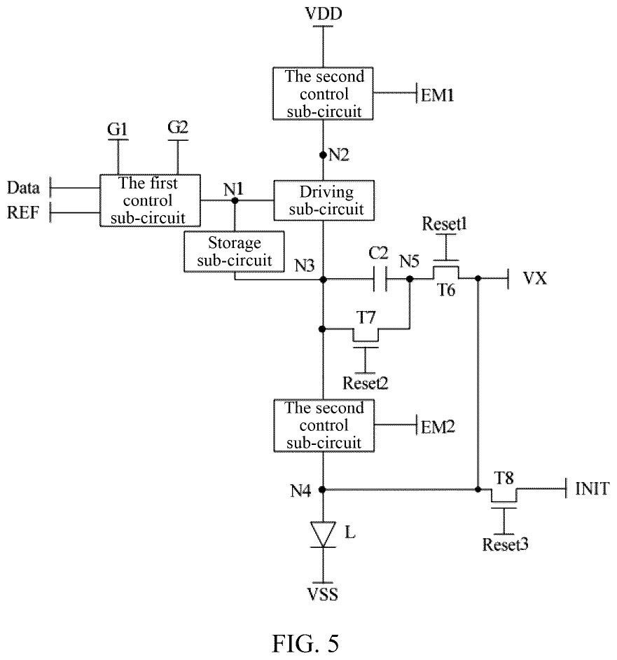

FIG. 4 is an equivalent circuit diagram III of a third control sub-circuit, and FIG. 5 is an equivalent circuit diagram IV of a third control sub-circuit. In an exemplary embodiment, as shown in FIGS. 4 and 5, the third control sub-circuit may be electrically connected to the third reset signal line Reset3 and the initial signal line INIT, respectively, and configured to provide a signal of the initial signal line to the fourth node N4 under control of a signal of the third reset signal line Reset3. Exemplarily, the third control sub-circuit may further include an eighth transistor T8, a control electrode of the eighth transistor T8 is electrically connected to the third reset signal line Reset3, a first electrode of the eighth transistor T8 is electrically connected to the initial signal line, and a second electrode of the eighth transistor T8 is electrically connected to the fourth node N4.

In an exemplary embodiment, a signal of the auxiliary signal line VX is a DC signal, and a signal of the auxiliary signal line VX is the same as a signal of any one of the initial signal line, the reference signal line REF, and the first power supply line VDD; alternatively, a signal of the auxiliary signal line VX is a non-DC signal, and a signal of the auxiliary signal line VX is electrically connected to the fourth node FIG. 4 is illustrated by taking a case that in which a signal of the auxiliary signal line VX is a DC signal as an example, and FIG. 5 is illustrated by taking a case that in which a signal of the auxiliary signal line VX is a non-DC signal as an example.

In an exemplary embodiment, as shown in FIGS. 4 and 5, when a signal of the first reset signal line Reset1 is an effective level signal, a signal of the third reset signal line is an effective level signal, a signal of the second reset signal line is an ineffective level signal, when the signal of the second reset signal line is an effective level signal, the signal of the first reset signal line is an ineffective level signal, the present disclosure, by enabling a signal of the second light emitting signal line EM2 to be an effective level signal during part of a time period in which a signal of the third reset signal line Reset3 is an effective level signal, can reset the third node N3 and the fourth node N4 prior to the writing time period, and can ensure the display uniformity of the pixel driving circuit. The present disclosure, by enabling the second reset signal line Reset2 to be an effective level signal during at least part of a time period after the writing time period, can make voltage values of signals at two ends of the second capacitor C2 in the light emitting stage the same, avoid the influence of the second capacitor C2 on the third node N3 in the light emitting stage, avoid the introduction of noise in the display stage, keep the stability of the driving current output by the pixel driving circuit, and improve the reliability of the pixel driving circuit.

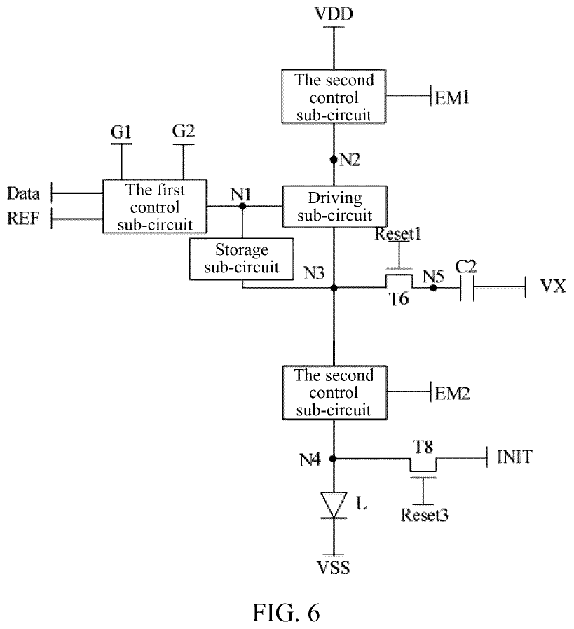

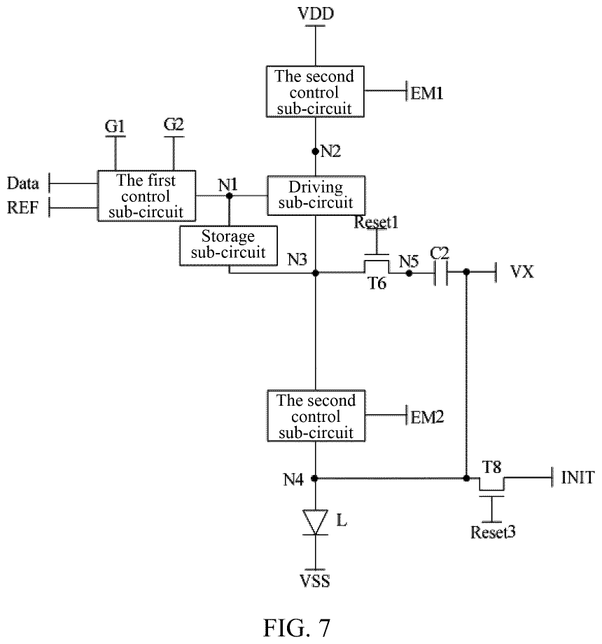

FIG. 6 is an equivalent circuit diagram V of a third control sub-circuit, and FIG. 7 is an equivalent circuit diagram VI of a third control sub-circuit. In an exemplary embodiment, as shown in FIGS. 6 and 7, the third control sub-circuit may be electrically connected to the third reset signal line Reset3 and the initial signal line INIT, respectively, and configured to provide a signal of the initial signal line to the fourth node N4 under control of a signal of the third reset signal line Reset3. Exemplarily, the third control sub-circuit may include a sixth transistor T6, an eighth transistor T8 and a second capacitor C2. A control electrode of the sixth transistor T6 is electrically connected to the first reset signal line Reset1, a first electrode of the sixth transistor T6 is electrically connected to the fifth node N5, and a second electrode of the sixth transistor T6 is electrically connected to the third node N3; a control electrode of the eighth transistor T8 is electrically connected to the third reset signal line Reset3, a first electrode of the eighth transistor T8 is electrically connected to the initial signal line INIT, and a second electrode of the eighth transistor T8 is electrically connected to the fourth node N4; a first terminal of the second capacitor C2 is electrically connected to the auxiliary signal line VX, and a second terminal of the second capacitor C2 is electrically connected to the fifth node N5.

In an exemplary embodiment, a signal of the auxiliary signal line VX is a DC signal, and the signal of the auxiliary signal line VX is the same as a signal of any one of the initial signal line, the reference signal line REF, and the first power supply line VDD; alternatively, a signal of the auxiliary signal line VX is a non-DC signal, and the signal of the auxiliary signal line VX is electrically connected to the fourth node N4. FIG. 6 is illustrated by taking a case in which a signal of the auxiliary signal line VX is a DC signal as an example, and FIG. 7 is illustrated by taking a case in which a signal of the auxiliary signal line VX is a non-DC signal as an example.

In an exemplary embodiment, as shown in FIGS. 6 and 7, the present disclosure, by enabling a signal of the second light emitting signal line EM2 to be an effective level signal during part of a time period in which a signal of the third reset signal line Reset3 is an effective level signal, can reset the third node N3 and the fourth node N4 prior to the writing time period, and can ensure the display uniformity of the pixel driving circuit. The present disclosure, by enabling the first reset signal line Reset1 to be an ineffective level signal during a time period after the writing time period, can prevent the second capacitor C2 from affecting the third node N3, avoid the introduction of noise in the display stage, keep the stability of the driving current output by the pixel driving circuit, and improve the reliability of the pixel driving circuit.

In an exemplary embodiment, the initial signal line INIT continuously provides a low-level signal and a signal of the initial signal line INIT is a DC signal.

In an exemplary embodiment, a voltage value of a signal of the initial signal line INIT may be smaller than a voltage value of a signal of the second power supply line VSS, which may avoid light emission error of the light emitting device L and may enhance the reliability of the pixel driving circuit.

Only six exemplary configurations of the third control sub-circuit are shown in FIGS. 2 to 7 and those skills in that art can easily understand that the implementation of the third control sub-circuit is not limit to this.

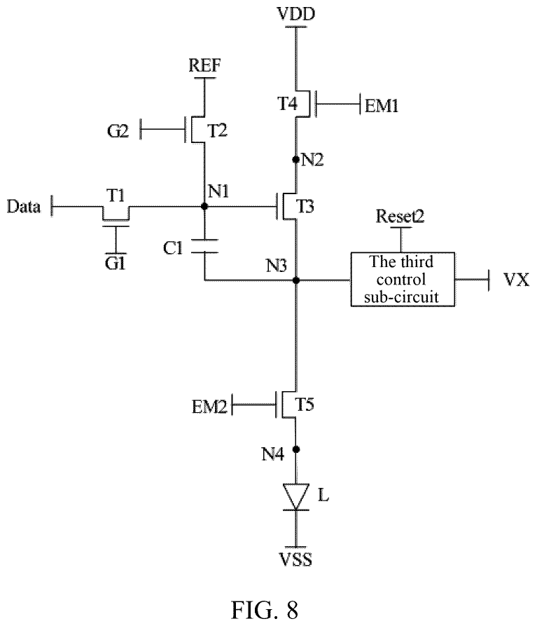

FIG. 8 is a partial equivalent circuit diagram of a pixel driving circuit. As shown in FIG. 8, in an exemplary embodiment, the first control sub-circuit may include a first transistor T1 and a second transistor T2, the driving sub-circuit may include a third transistor T3, the second control sub-circuit may include a fourth transistor T4 and a fifth transistor T5, and the storage sub-circuit may include a first capacitor C1. A control electrode of the first transistor T1 is electrically connected to the first scan signal line G1, a first electrode of the first transistor T1 is electrically connected to the data signal line Data, and a second electrode of the first transistor T1 is electrically connected to the first node N1; a control electrode of the second transistor T2 is electrically connected to the second scan signal line G2, a first electrode of the second transistor T2 is electrically connected to the reference signal line REF, and a second electrode of the second transistor T2 is electrically connected to the first node N1; a control electrode of the third transistor T3 is electrically connected to the first node N1, a first electrode of the third transistor T3 is electrically connected to the second node N2, and a second electrode of the third transistor T3 is electrically connected to the third node N3; a control electrode of the fourth transistor T4 is electrically connected to the first light emitting signal line EM1, a first electrode of the fourth transistor T4 is electrically connected to the first power supply line VDD, and a second electrode of the fourth transistor T4 is electrically connected to the second node N2; a control electrode of the fifth transistor T5 is electrically connected to the second light emitting signal line EM2, a first electrode of the fifth transistor T5 is electrically connected to the third node N3, and a second electrode of the fifth transistor T5 is electrically connected to the fourth node N4; a first terminal of the first capacitor C1 is electrically connected to the first node N1, and a second terminal of the first capacitor C1 is electrically connected to the third node N3.

Only one exemplary configuration of the driving sub-circuit, the first control sub-circuit, the second control sub-circuit, and the storage sub-circuit is shown in FIG. 8, and those skills in that art can easily understand that the embodiments of the driving sub-circuit, the first control sub-circuit, the second control sub-circuit, and the storage sub-circuit are not limited this.

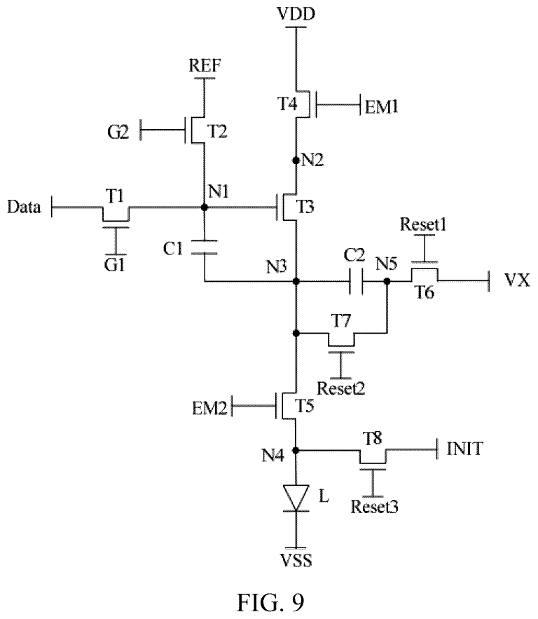

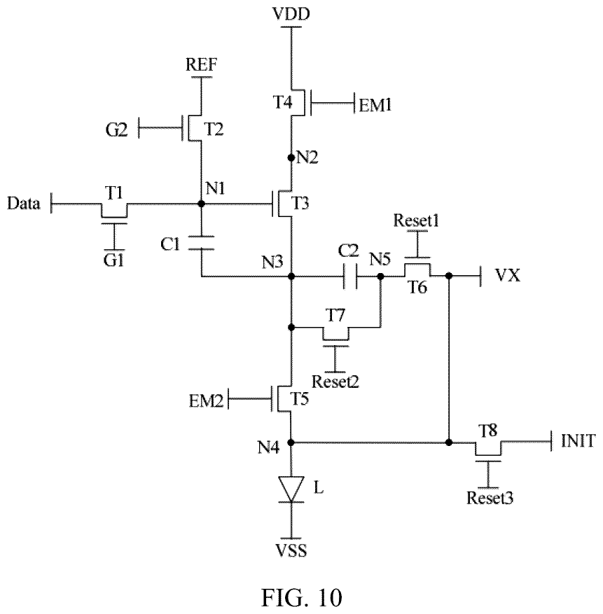

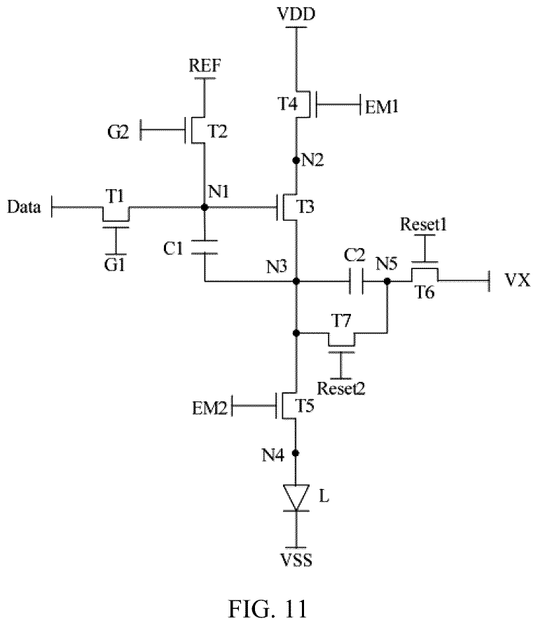

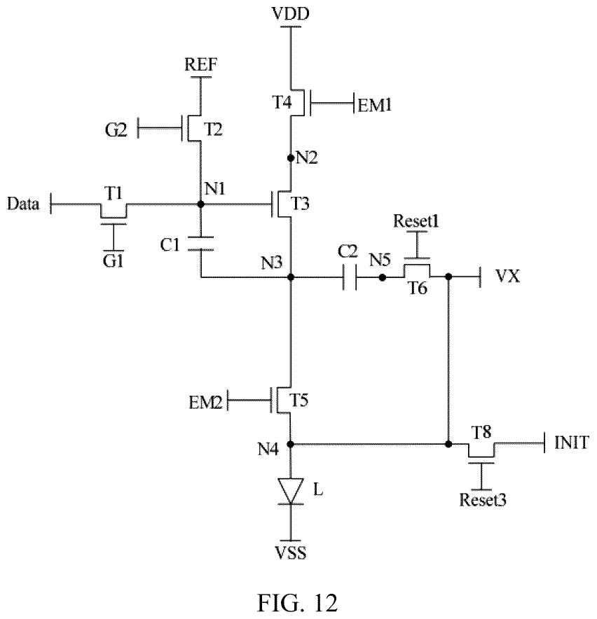

In an exemplary embodiment, FIG. 9 is an equivalent circuit diagram I of a pixel driving circuit, FIG. 10 is an equivalent circuit diagram II of a pixel driving circuit, FIG. 11 is an equivalent circuit diagram III of a pixel driving circuit, and FIG. 12 is an equivalent circuit diagram IV of a pixel driving circuit. As shown in FIGS. 9 to 12, in an exemplary embodiment, in the pixel driving circuit, the first control sub-circuit includes a first transistor T1 and a second transistor T2, the driving sub-circuit includes a third transistor T3, the second control sub-circuit includes a fourth transistor T4 and a fifth transistor T5, the storage sub-circuit includes a first capacitor C1, the third control sub-circuit includes a second capacitor C2 and a sixth transistor T6, and the third control sub-circuit further includes at least one of a seventh transistor T7 and an eighth transistor T8. A control electrode of the first transistor T1 is electrically connected to the first scan signal line G1, a first electrode of the first transistor T1 is electrically connected to the data signal line Data, and a second electrode of the first transistor T1 is electrically connected to the first node N1; a control electrode of the second transistor T2 is electrically connected to the second scan signal line G2, a first electrode of the second transistor T2 is electrically connected to the reference signal line REF, and a second electrode of the second transistor T2 is electrically connected to the first node N1; a control electrode of the third transistor T3 is electrically connected to the first node N1, a first electrode of the third transistor T3 is electrically connected to the second node N2, and a second electrode of the third transistor T3 is electrically connected to the third node N3; a control electrode of the fourth transistor T4 is electrically connected to the first light emitting signal line EM1, a first electrode of the fourth transistor T4 is electrically connected to the first power supply line VDD, and a second electrode of the fourth transistor T4 is electrically connected to the second node N2; a control electrode of the fifth transistor T5 is electrically connected to the second light emitting signal line EM2, a first electrode of the fifth transistor T5 is electrically connected to the third node N3, and a second electrode of the fifth transistor T5 is electrically connected to the fourth node N4; a control electrode of the sixth transistor T6 is electrically connected to the first reset signal line Reset1, a first electrode of the sixth transistor T6 is electrically connected to the auxiliary signal line VX, and a second electrode of the sixth transistor T6 is electrically connected to the fifth node N5; a control electrode of the seventh transistor T7 is electrically connected to the second reset signal line Reset2, a first electrode of the seventh transistor T7 is electrically connected to the fifth node N5, and a second electrode of the seventh transistor T7 is electrically connected to the third node N3; a control electrode of the eighth transistor T8 is electrically connected to the third reset signal line Reset3, a first electrode of the eighth transistor T8 is electrically connected to the initial signal line INIT, and a second electrode of the eighth transistor T8 is electrically connected to the fourth node N4; a first terminal of the first capacitor C1 is electrically connected with the first node N1, and a second terminal of the first capacitor C1 is electrically connected with the third node N3; a first terminal of the second capacitor C2 is electrically connected to the fifth node N5, and a second terminal of the second capacitor C2 is electrically connected to the third node N3. FIGS. 9 and 10 are illustrated by taking a case in which the third control sub-circuit further include a seventh transistor T7 and an eighth transistor T8 as an example, FIG. 11 is illustrated by taking a case in which the third control sub-circuit further includes a seventh transistor T7 as an example, and FIG. 12 is illustrated by taking a case in which the third control sub-circuit further includes an eighth transistor T8 as an example.

In an exemplary embodiment, as shown in FIGS. 9 and 10, the third control sub-circuit further includes that a signal of the auxiliary signal line VX in the pixel driving circuit of the seventh transistor T7 and the eighth transistor T8 may be a DC signal or may be a non-DC signal, FIG. 9 is illustrated by taking a case in which that a signal of the auxiliary signal line VX in the pixel driving circuit is a DC signal and is the same as a signal of any one of the initial signal line INIT, the reference signal line REF and the first power supply line VDD as an example, and FIG. 10 is illustrated by taking a case in which a signal of the auxiliary signal line VX in the pixel driving circuit is a non-DC signal and is electrically connected to the fourth node N4 as an example.

In an exemplary embodiment, as shown in FIG. 11, the third control sub-circuit further includes that a signal of the auxiliary signal line VX in the pixel driving circuit of the seventh transistor T7 is a DC signal and is the same as a signal of any one of the initial signal line, the reference signal line and the first power supply line.

In an exemplary embodiment, as shown in FIG. 12, the third control sub-circuit further includes that a signal of the auxiliary signal line VX in the pixel driving circuit of the eighth transistor T8 is a non-DC signal and is electrically connected to the fourth node N4.

Transistors may be divided into N-type transistors and P-type transistors according to their characteristics. When a transistor is a P-type transistor, its turn-on voltage is a low-level voltage (e.g., 0V, −5 V, −10 V, or another suitable voltage), and its turn-off voltage is a high-level voltage (e.g., 5 V, 10 V, or another suitable voltage). When a transistor is an N-type transistor, its turn-on voltage is a high-level voltage (e.g., 5 V, 10 V, or another suitable voltage), and its turn-off voltage is a low-level voltage (e.g., 0 V, −5 V, −10 V, or another suitable voltage).

In an exemplary embodiment, any of the first transistor T1 to the eighth transistor T8 may be made of an oxide thin film transistor. An active layer of the oxide thin film transistor is made of an oxide semiconductor (Oxide). The oxide thin film transistor has advantages such as low drain current.

In an exemplary embodiment, any of the first transistor T1 to the eighth transistor T8 is an N-type transistor.

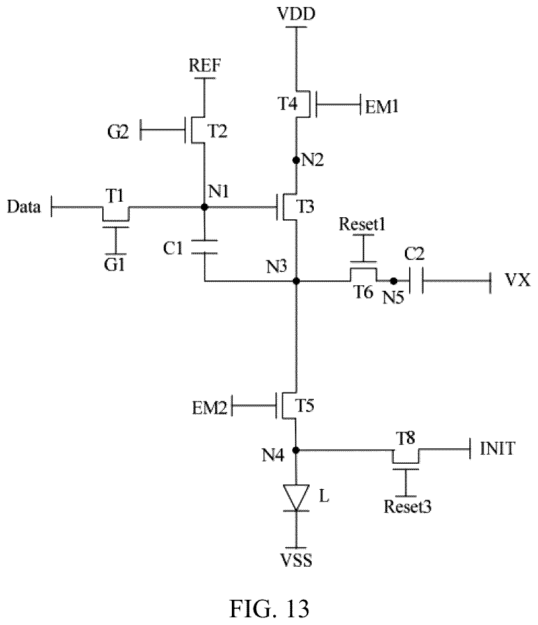

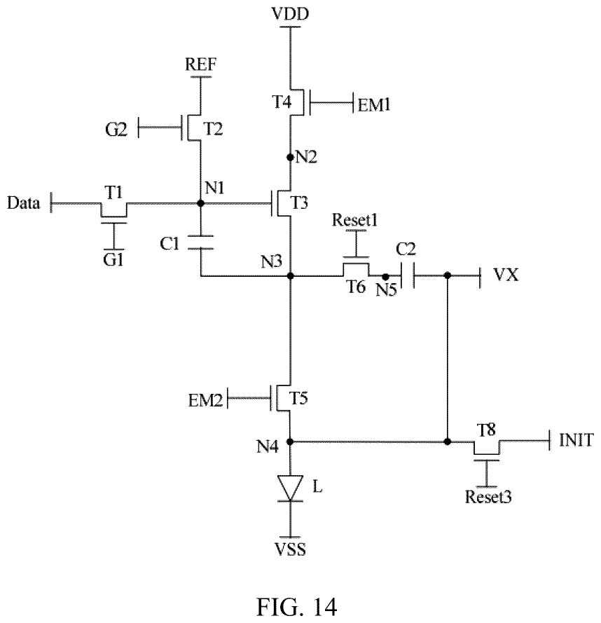

In an exemplary embodiment, FIG. 13 is an equivalent circuit diagram V of a pixel driving circuit and FIG. 14 is an equivalent circuit diagram VI of a pixel driving circuit. As shown in FIGS. 13 and 14, in the pixel driving circuit, the first control sub-circuit may include a first transistor T1 and a second transistor T2, the driving sub-circuit may include a third transistor T3, the second control sub-circuit may include a fourth transistor T4 and a fifth transistor T5, and the storage sub-circuit may include a first capacitor C1, the third control sub-circuit may include a second capacitor C2, a sixth transistor T6 and an eighth transistor T8. A control electrode of the first transistor T1 is electrically connected to the first scan signal line G1, a first electrode of the first transistor T1 is electrically connected to the data signal line Data, and a second electrode of the first transistor T1 is electrically connected to the first node N1; a control electrode of the second transistor T2 is electrically connected to the second scan signal line G2, a first electrode of the second transistor T2 is electrically connected to the reference signal line REF, and a second electrode of the second transistor T2 is electrically connected to the first node N1; a control electrode of the third transistor T3 is electrically connected to the first node N1, a first electrode of the third transistor T3 is electrically connected to the second node N2, and a second electrode of the third transistor T3 is electrically connected to the third node N3; a control electrode of the fourth transistor T4 is electrically connected to the first light emitting signal line EM1, a first electrode of the fourth transistor T4 is electrically connected to the first power supply line VDD, and a second electrode of the fourth transistor T4 is electrically connected to the second node N2; a control electrode of the fifth transistor T5 is electrically connected to the second light emitting signal line EM2, a first electrode of the fifth transistor T5 is electrically connected to the third node N3, and a second electrode of the fifth transistor T5 is electrically connected to the fourth node N4; a control electrode of the sixth transistor T6 is electrically connected to the first reset signal line Reset1, a first electrode of the sixth transistor T6 is electrically connected to the fifth node N5, and a second electrode of the sixth transistor T6 is electrically connected to the third node N3; a control electrode of the eighth transistor T8 is electrically connected to the third reset signal line Reset3, a first electrode of the eighth transistor T8 is electrically connected to the initial signal line INIT, and a second electrode of the eighth transistor T8 is electrically connected to the fourth node N4; a first terminal of the first capacitor C1 is electrically connected with the first node N1, and a second terminal of the first capacitor C1 is electrically connected with the third node N3; and a first terminal of the second capacitor C2 is electrically connected to the auxiliary signal line VX, and a second terminal of the second capacitor C2 is electrically connected to the fifth node N5.

In an exemplary embodiment, as shown in FIGS. 13 and 14, the third control sub-circuit includes the sixth transistor T6, the eighth transistor T8 and the second capacitor C2, a signal of the auxiliary signal line VX in the pixel driving circuit of the sixth transistor T6, the eighth transistor T8 and the second capacitor C2 may be a DC signal or a non-DC signal. FIG. 13 is illustrated by taking a case in which a signal of the auxiliary signal line VX in the pixel driving circuit is a DC signal and is the same as a signal of any one of the initial signal line INIT, the reference signal line REF and the first power supply line VDD as an example, and FIG. 14 is illustrated by taking a case in which a signal of the auxiliary signal line VX in the pixel driving circuit is a non-DC signal and is electrically connected to the fourth node N4 as an example.

In an exemplary embodiment, any of the first transistor T1, the second transistor T2, the fourth transistor T4, the fifth transistor T5, the sixth transistor T6, and the eighth transistor T8 may be made of an oxide thin film transistor. An active layer of the oxide thin film transistor is made of an oxide semiconductor (Oxide). The oxide thin film transistor has advantages such as low drain current.

In an exemplary embodiment, any of the first transistor T1, the second transistor T2, the fourth transistor T4, the fifth transistor T5, the sixth transistor T6, and the eighth transistor T8 is an N-type transistor.

In an exemplary embodiment, in the pixel driving circuit as provided in FIGS. 9 to 14, a quantity of the first transistor T1, the second transistor T2 and the fourth transistor T4 may be at least one.

In an exemplary embodiment, when a quantity of the first transistors T1 may be at least two, control electrodes of all the first transistors are electrically connected to the first scan signal line, at least two first transistors are provided in series, a first electrode of a first first transistor is electrically connected to the data signal line, and a second electrode of a last first transistor is electrically connected to the first node N1.

In an exemplary embodiment, when a quantity of second transistors T2 may be at least two, control electrodes of all second transistors T2 are electrically connected to the second scan signal line, at least two second transistors are provided in series, a first electrode of a first second transistor is electrically connected to the reference signal line, and a second electrode of a last second transistor is electrically connected to the second node N2.

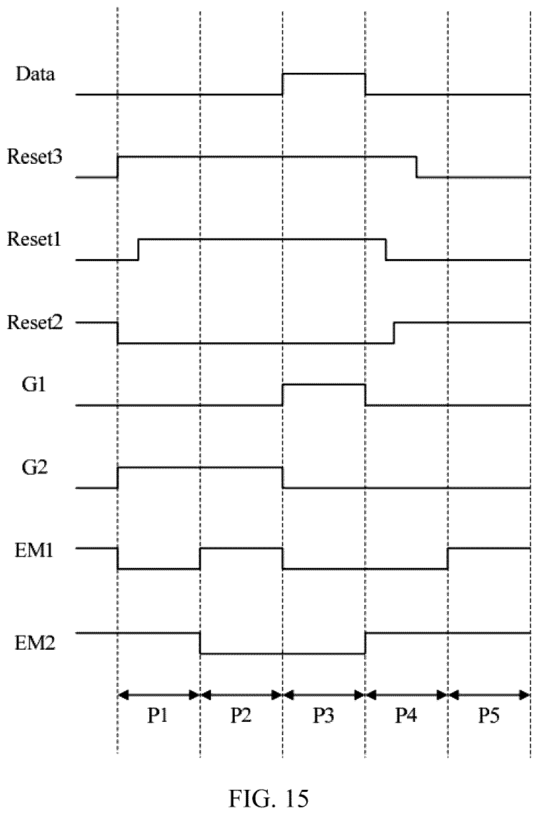

FIG. 15 is a working timing diagram of the pixel driving circuit provided in FIGS. 9 and 10. Exemplary embodiments of the present disclosure will be described below with reference to a working process of the pixel driving circuit illustrated in FIGS. 9 and 10, the pixel driving circuit in FIGS. 9 and 10 includes eight transistors (a first transistor T1 to an eighth transistor T8) and two capacitors (a first capacitor C1 and a second capacitor C2), and the eight transistors are all N-type transistors.

In an exemplary embodiment, a working process of the pixel driving circuit provided in FIGS. 9 and 10 may include following stages.

In a first stage P1 referred to as a first reset stage, signals of the second scan signal line G2, the second light emitting signal line EM2, the first reset signal line Reset1 and the third reset signal line Reset3 are high-level signals, and signals of the first scan signal line G1, the first light emitting signal line EM1 and the second reset signal line Reset2 are low-level signals. When a signal of the second scan signal line G2 is a high-level signal, the second transistor T2 is turned on, a signal of the reference signal line REF is written into the second node N2 to initialize (reset) a signal of the second node N2 and clear an original charge in the second node N2. A signal of the first reset signal line Reset1 is a high-level signal, the sixth transistor T6 is turned on, a signal of the auxiliary signal line VX is written into the fifth node N5 to initialize (reset) a signal of the fifth node N5 and clear an original charge in the fifth node N5. Signals of the second light emitting signal line EM2 and the third reset signal line Reset3 are high-level signals, the fifth transistor T5 and the eighth transistor T8 are turned on, and a signal of the initial signal line INIT is written into the third node N3 and the fourth node N4, respectively. Because a voltage value of a signal of the first node N1 and a voltage value of a signal of the third node N3 are greater than a threshold voltage of the third transistor T3, at this time, the third transistor T3 is turned on, and a signal of the initial signal line INIT is written into the second node N2, to initialize (reset) signals of the second node N2, the third node N3 and the fourth node N4 and clear original charges in the second node N2, the third node N3 and the fourth node N4. Signals of the first scan signal line G1, the first light emitting signal line EM1, and the second reset signal line Reset2 are low-level signals, and the first transistor T1, the fourth transistor T4, and the seventh transistor T7 are turned off. The light emitting device L does not emit light in this stage.

In a second stage P2, that is, a threshold compensation stage, signals of the first reset signal line Reset1, the third reset signal line Reset3, the second scan signal line G2 and the first light emitting signal line EM1 are high-level signals, and signals of the second reset signal line Reset2, the first scan signal line G1 and the second light emitting signal line EM2 are low-level signals. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the second scan signal line G2 is a high-level signal, the second transistor T2 is turned on, a signal of the reference signal line REF is continuously provided to the second node N2, a signal of the first light emitting signal line EM1 is a high-level signal, the fourth transistor T4 is turned on, and a signal of the first power supply line VDD is written to the third node N3 through the turned-on fourth transistor T4, the second node N2 and the turned-on third transistor T3 until a voltage of a signal of the third node N3 is V3=Vref−Vth, Vref is a voltage value of a signal of the initial signal line REF, and Vth is the threshold voltage of the third transistor T3, at this time, the first capacitor C1 stores a voltage difference Vth between signals of the first node N1 and the third node N3, signals of the second reset signal line Reset2, the first scan signal line G1, and the second light emitting signal line EM2 are low-level signals, and the first transistor T1, the fifth transistor T5, and the seventh transistor T7 are turned off. The light emitting device L does not emit light in this stage.

In a third stage P3, a data writing stage, signals of the first reset signal line Reset1, the third reset signal line Reset3 and the first scan signal line G1 are high-level signals, signals of the second reset signal line Reset2, the second scan signal line G2, the first light emitting signal line EM1 and the second light emitting signal line EM2 are low-level signals, and the data signal line Data outputs a data voltage. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the first scan signal line G1 is a high-level signal, the first transistor T1 is turned on, and a data voltage of the data signal line Data is written into the first node N1. At this time, a voltage value of the first node N1 is V1=Vdata, and Vdata is a data voltage of the data signal line. The voltage value of the signal of the first node N1 jumps in this stage compared to the voltage value thereof in the previous stage. Therefore, a signal of the third node N3 jumps under the action of the first capacitor C1 and the second capacitor C2. At this time, a voltage value of a signal of the third node N3 is V3=Vref−Vth+(Vdata−Vref)*C₁/(C₁+C₂), where C₁ is a capacitance value of the first capacitor and C₂ is a capacitance value of the second capacitor. Signals of the second reset signal line Reset2, the second scan signal line G2, the first light emitting signal line EM1 and the second light emitting signal line EM2 are low-level signals, and the second transistor T2, the fourth transistor T4, the fifth transistor T5 and the seventh transistor T7 are turned off. The light emitting device L does not emit light in this stage.

In a fourth stage P4 referred to as a second reset stage, the second reset signal line Reset2, the third reset signal line Reset3 and the second light emitting signal line EM2 are high-level signals, and signals of the first reset signal line Reset1, the first light emitting signal line EM1, the first scan signal line G1 and the second scan signal line G2 are low-level signals. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the second light emitting signal line EM2 is a high-level signal, the fifth transistor T5 is turned on, a voltage of a signal of the third node N3 is V3=Vinit, and Vinit is a voltage value of a signal of the initial signal line. At this time, the first node N1 is pulled down under the action of the first capacitor C1, so that a voltage of a signal of the first node N1 is V1=Vdata−[Vref−Vth+ (Vdata−Vref)*C₁/(C₁+C₂)]+Vinit, a signal of the second reset signal line Reset2 is a high-level signal, the seventh transistor T7 is turned on, and voltages of signals of the third node N3 and the fifth node N5 are consistent. Signals of the first reset signal line Reset1, the first light emitting signal line EM1, the first scan signal line G1 and the second scan signal line G2 are low-level signals, and the first transistor T1, the second transistor T2, the fourth transistor T4 and the sixth transistor T6 are turned off. The light emitting device L does not emit light in this stage.

In a fifth stage P5, that is, a light emitting stage, signals of the second reset signal line Reset2, the first light emitting signal line EM1 and the second light emitting signal line EM2 are high-level signals, and signals of the first reset signal line Reset1, the third reset signal line Reset3, the first scan signal line G1 and the second scan signal line G2 are low-level signals. Signals of the first light emitting signal line EM1 and the second light emitting signal line EM2 are high-level signals, the fourth transistor T4 and the fifth transistor T5 are turned on, a power supply voltage output by the first power supply line VDD provides driving voltage to a first electrode of the light emitting device L through the fourth transistor T4, the third transistor T3 and the fifth transistor T5 which are turned on to drive the light emitting device L to emit light, a signal of the second reset signal line Reset2 is high-level signal, the seventh transistor T7 is turned on, and the voltages of signals of the third node N3 and the fifth node N5 are consistent. Signals of the first reset signal line Reset1, the third reset signal line Reset3, the first scan signal line G1 and the second scan signal line G2 are low-level signals, and the first transistor T1, the second transistor T2, the sixth transistor T6 and the eighth transistor T8 are turned off. In this stage, the light emitting device L emits light.

In a drive process of the pixel driving circuit, the driving current flowing through the third transistor T3 (a driving transistor) is determined by a voltage difference between the control electrode (also the first node N1) and the second electrode (also the third node N3) of the third transistor T3. Because the voltage value of the signal of the first node is V1=Vdata−[Vref−Vth+(Vdata−Vref)*C₁/(C₁+C₂)]+Vinit and the voltage value of the signal of the third node N3 is V3=Vinit, the driving current of the third transistor T3 is as follows.

$$I = K * {( Vgs - Vth )}^{2} = K * {[ Vdata - [ Vref - Vth + ( Vdata - Vref ) * {C}_{1} / ( {C}_{1} + {C}_{2} ) ] - Vth ]}^{2} = K * {[ ( {C}_{2} / ( {C}_{1} + {C}_{2} ) ) * ( Vdata * Vref ) ]}^{2}$$

Herein, I is driving current flowing through the third transistor T3, that is, driving current driving the light emitting device L, K is a constant, and Vgs is a voltage difference between the control electrode and the second electrode of the third transistor T3.

It can be seen from the derivation result of the above current formula that in the light emitting stage, the driving current of the third transistor T3 is not affected by the threshold voltage of the third transistor T3. Therefore, the influence of the threshold voltage of the third transistor T3 on the driving current is eliminated, which can ensure uniformity of the display brightness of the display product, and improve the overall display effect of the display product.

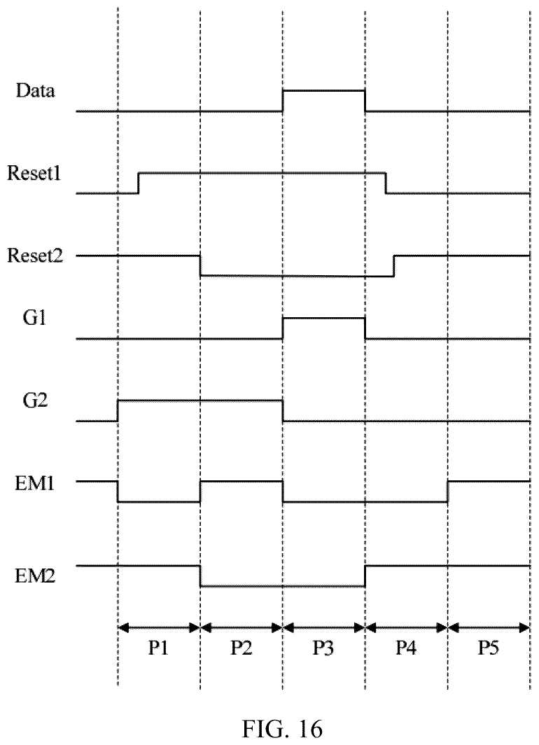

FIG. 16 is a working timing diagram of the pixel driving circuit provided in FIG. 11. An exemplary embodiment of the present disclosure will be described below through a working process of the pixel driving circuit exemplified in FIG. 11. The pixel driving circuit in FIG. 11 includes seven transistors (a first transistor T1 to a seventh transistor T7) and two capacitors (a first capacitor C1 and a second capacitor C2), and the seven transistors are all N-type transistors.

In an exemplary embodiment, a working process of the pixel driving circuit provided in FIG. 11 may include following stages.

In a first stage P1 referred to as a first reset stage, signals of the second scan signal line G2, the second light emitting signal line EM2, the first reset signal line Reset1 and the second reset signal line Reset2 are high-level signals, and signals of the first scan signal line G1 and the first light emitting signal line EM1 are low-level signals. A signal of the second scan signal line G2 is a high-level signal, the second transistor T2 is turned on, a signal of the reference signal line REF is written into the second node N2, to initialize (reset) a signal of the second node N2 and clear an original charge in the second node N2. Signals of the first reset signal line Reset1, the second reset signal line Reset2 and the second light emitting signal line EM2 are high-level signals, the fifth transistor T5, the sixth transistor T6 and the seventh transistor T7 are turned on, a signal of the auxiliary signal line VX is written into the fifth node N5, the third node N3 and the fourth node N4 sequentially, to initialize (reset) signals of the third node N3, the fourth node N4 and the fifth node N5, and clear original charges in the third node N3, the fourth node N4 and the fifth node N5. Signals of the first scan signal line G1 and the first light emitting signal line EM1 are low-level signals, and the first transistor T1 and the fourth transistor T4 are turned off. The light emitting device L does not emit light in this stage.

In a second stage P2, that is, a threshold compensation stage, signals of the first reset signal line Reset1, the second scan signal line G2 and the first light emitting signal line EM1 are high-level signals, and signals of the second reset signal line Reset2, the first scan signal line G1 and the second light emitting signal line EM2 are low-level signals. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the second scan signal line G2 is a high-level signal, the second transistor T2 is turned on, a signal of the reference signal line REF is continuously provided to the second node N2, a signal of the first light emitting signal line EM1 is a high-level signal, the fourth transistor T4 is turned on, and a signal of the first power supply line VDD is written to the third node N3 through the turned-on fourth transistor T4, the second node N2 and the turned-on third transistor T3 until a voltage of a signal of the third node N3 is V3=Vref−Vth, Vref is a voltage value of a signal of the initial signal line REF, and Vth is the threshold voltage of the third transistor T3, at this time, the first capacitor C1 stores a voltage difference Vth between signals of the first node N1 and the third node N3. Signals of the second reset signal line Reset2, the first scan signal line G1, and the second light emitting signal line EM2 are low-level signals, and the first transistor T1, the fifth transistor T5, and the seventh transistor are turned off. The light emitting device L does not emit light in this stage.

In a third stage P3, a data writing stage, signals of the first reset signal line Reset1 and the first scan signal line G1 are high-level signals, signals of the second reset signal line Reset2, the second scan signal line G2, the first light emitting signal line EM1 and the second light emitting signal line EM2 are low-level signals, and the data signal line Data outputs a data voltage. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the first scan signal line G1 is a high-level signal, the first transistor T1 is turned on, and a data voltage of the data signal line Data is written into the first node N1. At this time, a voltage value of the first node N1 is V1=Vdata, and Vdata is a data voltage of the data signal line. The voltage value of the signal of the first node N1 jumps in this stage compared to the voltage value thereof in the previous stage. Therefore, a signal of the third node N3 also jumps under the action of the first capacitor C1 and the second capacitor C2. At this time, a voltage value of a signal of the third node N3 is V3=Vref−Vth+ (Vdata−Vref)*C₁/(C₁+C₂), where C₁ is a capacitance value of the first capacitor and C₂ is a capacitance value of the second capacitor. Signals of the second reset signal line Reset2, the second scan signal line G2, the first light emitting signal line EM1 and the second light emitting signal line EM2 are low-level signals, and the second transistor T2, the fourth transistor T4, the fifth transistor T5 and the seventh transistor T7 are turned off. The light emitting device L does not emit light in this stage.

In a fourth stage P4 referred to as a second reset stage, the second reset signal line Reset2 and the second light emitting signal line EM2 are high-level signals, and signals of the first reset signal line Reset1, the first light emitting signal line EM1, the first scan signal line G1 and the second scan signal line G2 are low-level signals. A signal of the second light emitting signal line EM2 is a high-level signal, the fifth transistor T5 is turned on, a voltage of a signal of the third node N3 is V3=Vinit, and Vinit is a voltage value of a signal of the initial signal line. At this time, the first node N1 is pulled down under the action of the first capacitor C1, so that a voltage of a signal of the first node N1 is V1=Vdata−[Vref−Vth+ (Vdata−Vref)*C₁/(C₁+C₂)]+Vinit, a signal of the second reset signal line Reset2 is a high-level signal, the seventh transistor T7 is turned on, and voltages of signals of the third node N3 and the fifth node N5 are consistent. Signals of the first reset signal line Reset1, the first light emitting signal line EM1, the first scan signal line G1 and the second scan signal line G2 are low-level signals, and the first transistor T1, the second transistor T2, the fourth transistor T4 and the sixth transistor T6 are turned off. The light emitting device L does not emit light in this stage.

In a fifth stage P5, that is, a light emitting stage, signals of the second reset signal line Reset2, the first light emitting signal line EM1 and the second light emitting signal line EM2 are high-level signals, and signals of the first reset signal line Reset1, the first scan signal line G1 and the second scan signal line G2 are low-level signals. Signals of the first light emitting signal line EM1 and the second light emitting signal line Reset2 are high-level signals, the fourth transistor T4 and the fifth transistor T5 are turned on, a power supply voltage output by the first power supply line VDD provides driving voltage to a first electrode of the light emitting device L through the fourth transistor T4, the third transistor T3 and the fifth transistor T5 which are turned on to drive the light emitting device L to emit light, a signal of the second reset signal line Reset2 is high-level signal, the seventh transistor T7 is turned on, and the voltages of signals of the third node N3 and the fifth node N5 are consistent. Signals of the first reset signal line Reset1, the first scan signal line G1, and the second scan signal line G2 are low-level signals, the first transistor T1, the second transistor T2, and the sixth transistor T6 are turned off, and the light emitting device L emits light in this stage.

In a drive process of the pixel driving circuit, the driving current flowing through the third transistor T3 (a driving transistor) is determined by a voltage difference between the control electrode (also the first node N1) and the second electrode (also the third node N3) of the third transistor T3. Because the voltage value of the signal of the first node is V1=Vdata−[Vref−Vth+(Vdata−Vref)*C₁/(C₁+C₂)]+Vinit and the voltage value of the signal of the third node N3 is V3=Vinit, the driving current of the third transistor T3 is as follows.

$$I = K * {( Vgs - Vth )}^{2} = K * {[ Vdata - [ Vref - Vth + ( Vdata - Vref ) * {C}_{1} / ( {C}_{1} + {C}_{2} ) ] - Vth ]}^{2} = K * {[ ( {C}_{2} / ( {C}_{1} + {C}_{2} ) ) * ( Vdata - Vref ) ]}^{2}$$

Herein, I is driving current flowing through the third transistor T3, that is, driving current driving the light emitting device L, K is a constant, and Vgs is a voltage difference between the control electrode and the second electrode of the third transistor T3.

It can be seen from the derivation result of the above current formula that in the light emitting stage, the driving current of the third transistor T3 is not affected by the threshold voltage of the third transistor T3. Therefore, the influence of the threshold voltage of the third transistor T3 on the driving current is eliminated, which can ensure uniformity of the display brightness of the display product, and improve the overall display effect of the display product.

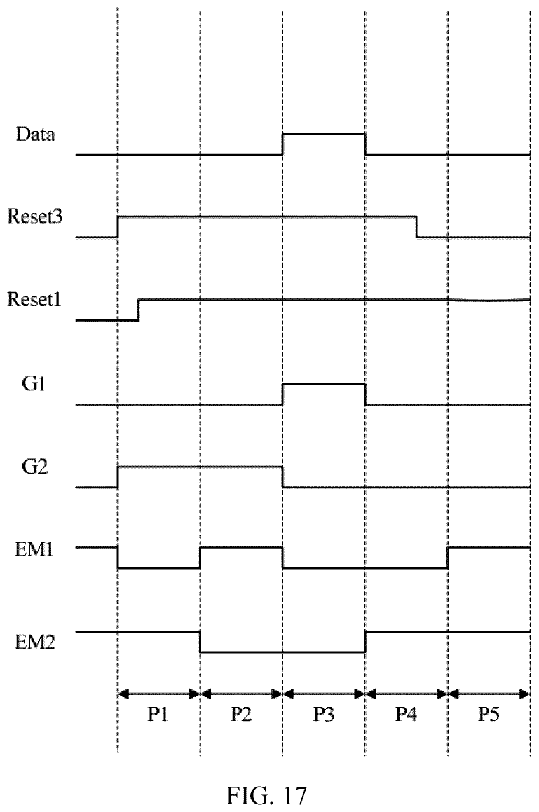

FIG. 17 is a working timing diagram of the pixel driving circuit provided in FIG. 12. An exemplary embodiment of the present disclosure will be described below through a working process of the pixel driving circuit exemplified in FIG. 12. The pixel driving circuit in FIG. 12 includes seven transistors (a first transistor T1 to a sixth transistor T6, an eighth transistor T8) and two capacitors (a first capacitor C1 and a second capacitor C2), and the seven transistors are all N-type transistors.

In an exemplary embodiment, a working process of the pixel driving circuit provided in FIG. 12 may include following stages.

In a first stage P1 referred to as a first reset stage, signals of the second scan signal line G2, the second light emitting signal line EM2, the first reset signal line Reset1 and the third reset signal line Reset3 are high-level signals, and signals of the first scan signal line G1 and the first light emitting signal line EM1 are low-level signals. A signal of the second scan signal line G2 is a high-level signal, the second transistor T2 is turned on, a signal of the reference signal line REF is written into the second node N2, to initialize (reset) a signal of the second node N2 and clear an original charge in the second node N2. A signal of the first reset signal line Reset1 is a high-level signal, the sixth transistor T6 is turned on, a signal of the auxiliary signal line VX is written into the fifth node N5 to initialize (reset) a signal of the fifth node N5 and clear an original charge in the fifth node N5. Signals of the second light emitting signal line EM2 and the third reset signal line Reset3 are high-level signals, the fifth transistor T5 and the eighth transistor T8 are turned on, and a signal of the initial signal line INIT is written into the third node N3 and the fourth node N4, respectively. Because a voltage value of a signal of the first node N1 and a voltage value of a signal of the third node N3 are greater than a threshold voltage of the third transistor T3, at this time, the third transistor T3 is turned on, and a signal of the initial signal line INIT is written into the second node N2, to initialize (reset) signals of the second node N2, the third node N3 and the fourth node N4 and clear original charges in the second node N2, the third node N3 and the fourth node N4. Signals of the first scan signal line G1 and the first light emitting signal line EM1 are low-level signals, and the first transistor T1 and the fourth transistor T4 are turned off. The light emitting device L does not emit light in this stage.

In a second stage P2, that is, a threshold compensation stage, signals of the first reset signal line Reset1, the third reset signal line Reset3, the second scan signal line G2 and the first light emitting signal line EM1 are high-level signals, and signals of the first scan signal line G1 and the second light emitting signal line EM2 are low-level signals. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the second scan signal line G2 is a high-level signal, the second transistor T2 is turned on, a signal of the reference signal line REF is continuously provided to the second node N2, a signal of the first light emitting signal line EM1 is a high-level signal, the fourth transistor T4 is turned on, and a signal of the first power supply line VDD is written to the third node N3 through the turned-on fourth transistor T4, the second node N2 and the turned-on third transistor T3 until a voltage of a signal of the third node N3 is V3=Vref−Vth, Vref is a voltage value of a signal of the initial signal line REF, and Vth is the threshold voltage of the third transistor T3, at this time, the first capacitor C1 stores a voltage difference Vth between signals of the first node N1 and the third node N3. Signals of the first scan signal line G1 and the second light emitting signal line EM2 are low-level signals, and the first transistor T1 and the fifth transistor T5 are turned off. The light emitting device L does not emit light in this stage.

In a third stage P3, a data writing stage, signals of the first reset signal line Reset1, the third reset signal line Reset3 and the first scan signal line G1 are high-level signals, signals of the second scan signal line G2, the first light emitting signal line EM1 and the second light emitting signal line EM2 are low-level signals, and the data signal line Data outputs a data voltage. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the first scan signal line G1 is a high-level signal, the first transistor T1 is turned on, and a data voltage of the data signal line Data is written into the first node N1. At this time, a voltage value of the first node N1 is V1=Vdata, and Vdata is a data voltage of the data signal line. The voltage value of the signal of the first node N1 jumps in this stage compared to the voltage value thereof in the previous stage. Therefore, a signal of the third node N3 also jumps under the action of the first capacitor C1 and the second capacitor C2. At this time, a voltage value of a signal of the third node N3 is V3=Vref−Vth+(Vdata−Vref)*C₁/(C₁+C₂), where C₁ is a capacitance value of the first capacitor and C₂ is a capacitance value of the second capacitor. Signals of the second scan signal line G2, the first light emitting signal line EM1, and the second light emitting signal line EM2 are low-level signals, and the second transistor T2, the fourth transistor T4, and the fifth transistor T5 are turned off. The light emitting device L does not emit light in this stage.

In a fourth stage P4 referred to as a second reset stage, the first reset signal line Reset1, the third reset signal line Reset3 and the second light emitting signal line EM2 are high-level signals, and signals of the first light emitting signal line EM1, the first scan signal line G1 and the second scan signal line G2 are low-level signals. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the second light emitting signal line EM2 is a high-level signal, the fifth transistor T5 is turned on, a voltage of a signal of the third node N3 is V3=Vinit, and Vinit is a voltage value of a signal of the initial signal line. At this time, the first node N1 is pulled down under the action of the first capacitor C1, so that a voltage of a signal of the first node N1 is V1=Vdata−[Vref−Vth+ (Vdata−Vref)*C₁/(C₁+C₂)]+Vinit, a signal of the first reset signal line Reset1 is a high-level signal, the sixth transistor T6 is turned on, and voltages of signals of the third node N3 and the fifth node N5 are consistent. Signals of the first reset signal line Reset1, the first light emitting signal line EM1, the first scan signal line G1, and the second scan signal line G2 are low-level signals, and the first transistor T1, the second transistor T2, and the fourth transistor T4 are turned off. The light emitting device L does not emit light in this stage.

In a fifth stage P5, that is, a light emitting stage, signals of the first reset signal line Reset1, the first light emitting signal line EM1 and the second light emitting signal line EM2 are high-level signals, and signals of the third reset signal line Reset3, the first scan signal line G1 and the second scan signal line G2 are low-level signals. Signals of the first light emitting signal line EM1 and the second light emitting signal line EM2 are high-level signals, the fourth transistor T4 and the fifth transistor T5 are turned on, a power supply voltage output by the first power supply line VDD provides driving voltage to a first electrode of the light emitting device L through the fourth transistor T4, the third transistor T3 and the fifth transistor T5 which are turned on to drive the light emitting device L to emit light, a signal of the first reset signal line Reset1 is high-level signal, the sixth transistor T6 is turned on, and voltages of signals of the third node N3 and the fifth node N5 are consistent. Signals of the third reset signal line Reset3, the first scan signal line G1, and the second scan signal line G2 are low-level signals, the first transistor T1, the second transistor T2, and the eighth transistor T8 are turned off, and the light emitting device L emits light in this stage.

In a drive process of the pixel driving circuit, the driving current flowing through the third transistor T3 (a driving transistor) is determined by a voltage difference between the control electrode (also the first node N1) and the second electrode (also the third node N3) of the third transistor T3. Because the voltage value of the signal of the first node is V1=Vdata−[Vref−Vth+(Vdata−Vref)*C₁/(C₁+C₂)]+Vinit and the voltage value of the signal of the third node N3 is V3=Vinit, the driving current of the third transistor T3 is as follows.

$$I = K * {( Vgs - Vth )}^{2} = K * {[ Vdata - [ Vref - Vth + ( Vdata - Vref ) * {C}_{1} / ( {C}_{1} + {C}_{2} ) ] - Vth ]}^{2} = K * {[ ( {C}_{2} / ( {C}_{1} + {C}_{2} ) ) * ( Vdata - Vref ) ]}^{2}$$

Herein, I is driving current flowing through the third transistor T3, that is, driving current driving the light emitting device L, K is a constant, and Vgs is a voltage difference between the control electrode and the second electrode of the third transistor T3.

It can be seen from the derivation result of the above current formula that in the light emitting stage, the driving current of the third transistor T3 is not affected by the threshold voltage of the third transistor T3. Therefore, the influence of the threshold voltage of the third transistor T3 on the driving current is eliminated, which can ensure uniformity of the display brightness of the display product, and improve the overall display effect of the display product.

In the fourth stage and the fifth stage for the pixel driving circuit provided in FIGS. 9 to 12, signals of the third node N3 and the fifth node N5 at two ends of the second capacitor C2 are consistent, so that the third node of the pixel driving circuit is not affected by the coupling of the second capacitor C2 in the fifth stage, which can improve the stability of the driving current of the pixel driving circuit and improve the reliability of the pixel driving circuit.

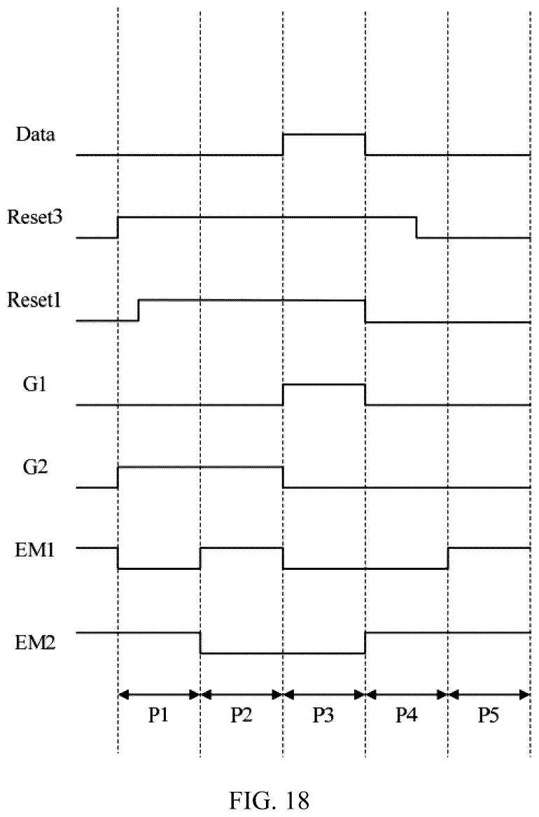

FIG. 18 is a working timing diagram of the pixel driving circuit provided in FIGS. 13 and 14. An exemplary embodiment of the present disclosure will be described below through a working process of the pixel driving circuit exemplified in FIGS. 13 and 14. The pixel driving circuit in FIGS. 13 and 14 includes seven transistors (a first transistor T1 to a sixth transistor T6, an eighth transistor T8) and two capacitors (a first capacitor C1 and a second capacitor C2), and the seven transistors are all N-type transistors.

In an exemplary embodiment, a working process of the pixel driving circuit provided in FIGS. 13 and 14 may include following stages.

In a first stage P1 referred to as a first reset stage, signals of the second scan signal line G2, the second light emitting signal line EM2, the first reset signal line Reset1 and the third reset signal line Reset3 are high-level signals, and signals of the first scan signal line G1 and the first light emitting signal line EM1 are low-level signals. When the signal of the second scan signal line G2 is a high-level signal, the second transistor T2 is turned on, a signal of the reference signal line REF is written into the second node N2, to initialize (reset) a signal of the second node N2 and clear an original charge in the second node N2. A signal of the first reset signal line Reset1 is a high-level signal, the sixth transistor T6 is turned on, a signal of the auxiliary signal line VX is written into the fifth node N5 to initialize (reset) a signal of the fifth node N5 and clear an original charge in the fifth node N5. Signals of the second light emitting signal line EM2 and the third reset signal line Reset3 are high-level signals, the fifth transistor T5 and the eighth transistor T8 are turned on, and a signal of the initial signal line INIT is written into the third node N3 and the fourth node N4, respectively. Because a voltage value of a signal of the first node N1 and a voltage value of a signal of the third node N3 are greater than a threshold voltage of the third transistor T3, at this time, the third transistor T3 is turned on, and a signal of the initial signal line INIT is written into the second node N2, to initialize (reset) signals of the second node N2, the third node N3 and the fourth node N4 and clear original charges in the second node N2, the third node N3 and the fourth node N4. Signals of the first scan signal line G1 and the first light emitting signal line EM1 are low-level signals, and the first transistor T1 and the fourth transistor T4 are turned off. The light emitting device L does not emit light in this stage.

In a second stage P2, that is, a threshold compensation stage, signals of the first reset signal line Reset1, the third reset signal line Reset3, the second scan signal line G2 and the first light emitting signal line EM1 are high-level signals, and signals of the first scan signal line G1 and the second light emitting signal line EM2 are low-level signals. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the second scan signal line G2 is a high-level signal, the second transistor T2 is turned on, a signal of the reference signal line REF is continuously provided to the second node N2, a signal of the first light emitting signal line EM1 is a high-level signal, the fourth transistor T4 is turned on, and a signal of the first power supply line VDD is written to the third node N3 through the turned-on fourth transistor T4, the second node N2 and the turned-on third transistor T3 until a voltage of a signal of the third node N3 is V3=Vref−Vth, Vref is a voltage value of a signal of the initial signal line REF, and Vth is the threshold voltage of the third transistor T3, at this time, the first capacitor C1 stores a voltage difference Vth between signals of the first node N1 and the third node N3. Signals of the first scan signal line G1 and the second light emitting signal line EM2 are low-level signals, and the first transistor T1 and the fifth transistor T5 are turned off. The light emitting device L does not emit light in this stage.

In a third stage P3, a data writing stage, signals of the first reset signal line Reset1, the third reset signal line Reset3 and the first scan signal line G1 are high-level signals, signals of the second scan signal line G2, the first light emitting signal line EM1 and the second light emitting signal line EM2 are low-level signals, and the data signal line Data outputs a data voltage. A signal of the first reset signal line Reset1 is a high-level signal, the sixth transistor T6 is turned on, a signal of the auxiliary signal line VX is continuously written to the fifth node N5, to continuously initialize (reset) a signal of the fifth node N5. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the first scan signal line G1 is a high-level signal, the first transistor T1 is turned on, and a data voltage of the data signal line Data is written into the first node N1. At this time, a voltage value of the first node N1 is V1=Vdata, and Vdata is a data voltage of the data signal line. The voltage value of the signal of the first node N1 jumps in this stage compared to the voltage value thereof in the previous stage. Therefore, a signal of the third node N3 also jumps under the action of the first capacitor C1 and the second capacitor C2. At this time, a voltage value of a signal of the third node N3 is V3=Vref−Vth+ (Vdata−Vref)*C₁/(C₁+C₂), where C₁ is a capacitance value of the first capacitor and C₂ is a capacitance value of the second capacitor. Signals of the second scan signal line G2, the first light emitting signal line EM1, and the second light emitting signal line EM2 are low-level signals, and the second transistor T2, the fourth transistor T4, and the fifth transistor T5 are turned off. The light emitting device L does not emit light in this stage.

In a fourth stage P4 referred to as a second reset stage, the third reset signal line Reset3 and the second light emitting signal line EM2 are high-level signals, and signals of the first reset signal line Reset1, the first light emitting signal line EM1, the first scan signal line G1 and the second scan signal line G2 are low-level signals. A signal of the third reset signal line Reset3 is a high-level signal, the eighth transistor T8 is turned on, a signal of the initial signal line INIT is continuously written to the fourth node N4, to continuously initialize (reset) a signal of the fourth node N4. A signal of the second light emitting signal line EM2 is a high-level signal, the fifth transistor T5 is turned on, a voltage of a signal of the third node N3 is V3=Vinit, and Vinit is a voltage value of a signal of the initial signal line. At this time, the first node N1 is pulled down under the action of the first capacitor C1, so that a voltage of a signal of the first node N1 is V1=Vdata−[Vref−Vth+(Vdata−Vref)*C₁/(C₁+C₂)]+Vinit. Signals of the first reset signal line Reset1, the first light emitting signal line EM1, the first scan signal line G1 and the second scan signal line G2 are low-level signals, and the first transistor T1, the second transistor T2, the fourth transistor T4 and the sixth transistor T6 are turned off. The light emitting device L does not emit light in this stage.

In a fifth stage P5, that is, a light emitting stage, signals of the first light emitting signal line EM1 and the second light emitting signal line EM2 are high-level signals, and signals of the first reset signal line Reset1, the third reset signal line Reset3, the first scan signal line G1 and the second scan signal line G2 are low-level signals. Signals of the first light emitting signal line EM1 and the second light emitting signal line EM2 are high-level signals, the fourth transistor T4 and the fifth transistor T5 are turned on, a power supply voltage output by the first power supply line VDD provides driving voltage to a first electrode of the light emitting device L through the fourth transistor T4, the third transistor T3 and the fifth transistor T5 which are turned on to drive the light emitting device L to emit light, a signal of the first reset signal line Reset1 is high-level signal, the sixth transistor T6 is turned on, and voltages of signals of the third node N3 and the fifth node N5 are consistent. Signals of the first reset signal line Reset1, the third reset signal line Reset3, the first scan signal line G1 and the second scan signal line G2 are low-level signals, the first transistor T1, the second transistor T2, the sixth transistor T6 and the eighth transistor T8 are turned off, and the light emitting device L emits light in this stage.

In a drive process of the pixel driving circuit, the driving current flowing through the third transistor T3 (a driving transistor) is determined by a voltage difference between the control electrode (also the first node N1) and the second electrode (also the third node N3) of the third transistor T3. Because the voltage value of the signal of the first node is V1=Vdata−[Vref−Vth+(Vdata−Vref)*C₁/(C₁+C₂)]+Vinit and the voltage value of the signal of the third node N3 is V3=Vinit, the driving current of the third transistor T3 is as follows.

$$I = K * {( Vgs - Vth )}^{2} = K * {[ Vdata - [ Vref - Vth + ( Vdata - Vref ) * {C}_{1} / ( {C}_{1} + {C}_{2} ) ] - Vth ]}^{2} = K * {[ ( {C}_{2} / ( {C}_{1} + {C}_{2} ) ) * ( Vdata - Vref ) ]}^{2}$$

Herein, I is driving current flowing through the third transistor T3, that is, driving current driving the light emitting device L, K is a constant, and Vgs is a voltage difference between the control electrode and the second electrode of the third transistor T3.

It can be seen from the derivation result of the above current formula that in the light emitting stage, the driving current of the third transistor T3 is not affected by the threshold voltage of the third transistor T3. Therefore, the influence of the threshold voltage of the third transistor T3 on the driving current is eliminated, which can ensure uniformity of the display brightness of the display product, and improve the overall display effect of the display product.

In the fourth stage and the fifth stage for the pixel driving circuit provided in FIGS. 13 and 14, the second capacitor C2 is disconnected from the sixth transistor T6 which is disconnected from the third node N3, so that the third node of the pixel driving circuit is not affected by the coupling of the second capacitor C2 in the fifth stage, which can improve the stability of the driving current of the pixel driving circuit and improve the reliability of the pixel driving circuit.

The embodiment of the present disclosure further provides a driving method for the pixel driving circuit, which is configured to drive the pixel driving circuit. The driving method for the pixel driving circuit may include following acts.

Act 100: the driving sub-circuit provides driving current to the third node under control of signals of the first node and the second node.

Act 200: the first control sub-circuit provides a signal of the data signal line or the reference signal line to the first node N1 under control of signals of the first scan signal line and the second scan signal line.

Act 300: the second control sub-circuit provides a signal of the first power supply line to the second node and provides a signal of the third node to the fourth node under control of signals of the first light emitting signal line and the second light emitting signal line.

Act 400: the third control sub-circuit controls a signal of the third node under control of a signal of the first reset signal line and under drive of a signal of the auxiliary signal line.

Act 500: the storage sub-circuit stores the voltage difference of signals between the first node and the third node.

The embodiment of the present disclosure further provides a driving method for the pixel driving circuit, which is configured to drive the pixel driving circuit provided in FIG. 11. A working process of the pixel driving circuit includes a first stage to a fifth stage. The driving method for the pixel driving circuit provided in FIG. 11 may include following acts.

Act 110: in the first stage, effective level signals are provided to signals of the second scan signal line, the second light emitting signal line, the first reset signal line and the second reset signal line, the first control sub-circuit provides a signal of the reference signal line to the first node, the third control sub-circuit provides a signal of the auxiliary signal line to the fifth node, and provides a signal of the fifth node to the third node, and the second control sub-circuit provides a signal of the fourth node to the third node.

Act 120: in the second stage, effective level signals are provided to the first reset signal line, the second scan signal line and the first light emitting signal line, the first control sub-circuit provides the signal of the reference signal line to the first node, the third control sub-circuit provides the signal of the auxiliary signal line to the fifth node, the second control sub-circuit provides a signal of the first power supply line to the second node to charge the first node, and the storage sub-circuit stores a voltage difference between signals of the first node and the third node.

Act 130: in the third stage, signals to the first reset signal line and the first scan signal line are high-level signals, the first control sub-circuit provides the signal of the data signal line to the first node, and the third control sub-circuit provides the signal of the auxiliary signal line to the fifth node.

Act 140: in the fourth stage, effective level signals are provided to the second reset signal line and the second light emitting signal line, the third control sub-circuit provides a signal of the third node to the fifth node, and the second control sub-circuit provides the signal of the fourth node to the third node.

Act 150: in the fifth stage, effective level signals are provided to the second reset signal line, the first light emitting signal line and the second light emitting signal line, the second control sub-circuit provides the signal of the first power supply line to the second node, the signal of the third node to the fourth node, the driving sub-circuit provides driving current to the third node under control of signals of the first node and the second node, and the third control sub-circuit provides the signal of the third node to the fifth node.

The embodiment of the present disclosure further provides a driving method for the pixel driving circuit, which is configured to drive the pixel driving circuit provided in FIG. 12. A working process of the pixel driving circuit comprises a first stage to a fifth stage. The driving method for the pixel driving circuit provided in FIG. 12 may include following acts.

Act 210: in the first stage, effective level signals are provided to signals of the second scan signal line, the second light emitting signal line, the first reset signal line and the third reset signal line, the first control sub-circuit provides a signal of the reference signal line to the first node, the third control sub-circuit provides a signal of the auxiliary signal line to the fifth node, and provides a signal of the initial signal line to the fourth node, and the second control sub-circuit provides a signal of the fourth node to the third node.

Act 220: in the second stage, effective level signals are provided to the first reset signal line, the third reset signal line, the second scan signal line and the first light emitting signal line, the first control sub-circuit provides the signal of the reference signal line to the first node, the third control sub-circuit provides the signal of the auxiliary signal line to the fifth node and a signal of the initial signal line to the fourth node, the second control sub-circuit provides a signal of the first power supply line to the second node to charge the first node, and the storage sub-circuit stores a voltage difference between signals of the first node and the third node.

Act 230: in the third stage, signals to the first reset signal line, the third reset signal line and the first scan signal line are high-level signals, the first control sub-circuit provides the signal of the data signal line to the first node, the third control sub-circuit provides the signal of the auxiliary signal line to the fifth node, and provides the signal of the initial signal line to the fourth node.

Act 240: in the fourth stage, effective level signals are provided to the first reset signal line, the third reset signal line and the second light emitting signal line, the third control sub-circuit provides the signal of the initial signal line to the fourth node, the signal of the auxiliary signal line to the fifth node, and the second control sub-circuit provides the signal of the fourth node to the third node.

Act 250: in the fifth stage, effective level signals are provided to the first reset signal line, the first light emitting signal line and the second light emitting signal line, the second control sub-circuit provides the signal of the first power supply line to the second node, the signal of the third node to the fourth node, the driving sub-circuit provides driving current to the third node under control of signals of the first node and the second node, and the third control sub-circuit provides the signal of the auxiliary signal line to the fifth node.

The embodiment of the present disclosure further provides a driving method for the pixel driving circuit, which is configured to drive the pixel driving circuit provided in FIGS. 9 and 10. A working process of the pixel driving circuit includes a first stage to a fifth stage. The driving method for the pixel driving circuit provided in FIGS. 9 and 10 may include following acts.

Act 310: in the first stage, effective level signals are provided to signals of the second scan signal line, the second light emitting signal line, the first reset signal line and the third reset signal line, the first control sub-circuit provides a signal of the reference signal line to the first node, the third control sub-circuit provides a signal of the auxiliary signal line to the fifth node, and provides a signal of the initial signal line to the fourth node, and the second control sub-circuit provides a signal of the fourth node to the third node.

Act 320: in the second stage, effective level signals are provided to the first reset signal line, the third reset signal line, the second scan signal line and the first light emitting signal line, the first control sub-circuit provides the signal of the reference signal line to the first node, the third control sub-circuit provides the signal of the auxiliary signal line to the fifth node and the signal of the initial signal line to the fourth node, the second control sub-circuit provides a signal of a first power supply line to the second node to charge the first node, and the storage sub-circuit stores a voltage difference between signals of the first node and the third node.

Act 330: in the third stage, signals to the first reset signal line, the third reset signal line and the first scan signal line are high-level signals, the first control sub-circuit provides the signal of the data signal line to the first node, the third control sub-circuit provides the signal of the auxiliary signal line to the fifth node, and provides the signal of the initial signal line to the fourth node.

Act 340: in the fourth stage, effective level signals are provided to the second reset signal line, the third reset signal line and the second light emitting signal line, the third control sub-circuit provides the signal of the initial signal line to the fourth node, the signal of the third node to the fifth node, and the second control sub-circuit provides the signal of the fourth node to the third node.

Act 350: in the fifth stage, effective level signals are provided to the second reset signal line, the first light emitting signal line and the second light emitting signal line, the second control sub-circuit provides the signal of the first power supply line to the second node, the signal of the third node to the fourth node, the driving sub-circuit provides driving current to the third node under control of signals of the first node and the second node, and the third control sub-circuit provides the signal of the third node to the fifth node.

The embodiment of the present disclosure further provides a driving method for the pixel driving circuit, which is configured to drive the pixel driving circuit provided in FIGS. 13 and 14. A working process of the pixel driving circuit includes a first stage to a fifth stage. The driving method for the pixel driving circuit provided in FIGS. 13 and 14 may include following acts.

Act 410: in the first stage, effective level signals are provided to signals of the second scan signal line, the second light emitting signal line, the first reset signal line and the third reset signal line, the first control sub-circuit provides a signal of the reference signal line to the first node, the third control sub-circuit provides a signal of the third node to the fifth node, and provides a signal of the initial signal line to the fourth node, and the second control sub-circuit provides a signal of the fourth node to the third node.

Act 420: in the second stage, effective level signals are provided to the first reset signal line, the third reset signal line, the second scan signal line and the first light emitting signal line, the first control sub-circuit provides the signal of the reference signal line to the first node, the third control sub-circuit provides the signal of the third node to the fifth node and the signal of the initial signal line to the fourth node, the second control sub-circuit provides a signal of the first power supply line to the second node to charge the first node, and the storage sub-circuit stores a voltage difference between signals of the first node and the third node.

Act 430: in the third stage, signals to the first reset signal line, the third reset signal line and the first scan signal line are high-level signals, the first control sub-circuit provides the signal of the data signal line to the first node, the third control sub-circuit provides the signal of the initial signal line to the fourth node, and provides the signal of the third node to the fifth node.

Act 440: in the fourth stage, effective level signals are provided to the third reset signal line and the second light emitting signal line, the third control sub-circuit provides the signal of the initial signal line to the fourth node, and the second control sub-circuit provides the signal of the fourth node to the third node.

Act 450: in the fifth stage, effective level signals are provided to the first light emitting signal line and the second light emitting signal line, the second control sub-circuit provides the signal of the first power supply line to the second node, the signal of the third node to the fourth node, and the driving sub-circuit provides driving current to the third node under control of signals of the first node and the second node.

The embodiment of the present disclosure further provides a display apparatus with a display region, and the display region is provided with a plurality of pixel driving circuits.

The pixel driving circuit is the pixel driving circuit provided in any of the foregoing embodiments and implementation and effects are similar, which will not be repeated here.

In an exemplary embodiment, the display apparatus may include a timing controller, a data driver, a scan driver, a light emitting driver, and a pixel array. The timing controller is connected with the data driver, the scan driver, and the light emitting driver, respectively, the data driver is connected with a plurality of data signal lines respectively, the scan driver is connected with a plurality of scan signal lines respectively, and the light emitting driver is connected with a plurality of light emitting signal lines respectively. The pixel array may include a plurality of sub-pixels, at least one sub-pixel may include a circuit unit and a light emitting device connected to the circuit unit, and the circuit unit may include a pixel driving circuit which may be connected to a scan signal line, a light emitting signal line and a data signal line, respectively.

The scan signal line includes a first scan signal line, a second scan signal line, a first reset signal line, a second reset signal line, and a third reset signal line. The light emitting signal line includes a first light emitting signal line and a second light emitting signal line.

In an exemplary embodiment, the timing controller may provide a grayscale value and a control signal suitable for a specification of the data driver to the data driver, may provide a clock signal, a scan start signal, etc. suitable for a specification of the scan driver to the scan driver, and may provide a clock signal, an emission stop signal, etc. suitable for a specification of the light emitting driver to the light emitting driver.

In an exemplary embodiment, the data driver may generate a data voltage to be provided to the data signal lines using the gray-scale value and the control signal received from the timing controller. For example, the data driver may sample the gray-scale value using the clock signal, and apply the data voltage corresponding to the gray-scale value to the data signal line by taking a pixel row as a unit.

In an exemplary embodiment, the scan driver may generate scan signals to be provided to the scan signal lines by receiving the clock signal, the scan start signal, or the like, from the timing controller. For example, the scan driver may sequentially provide scan signals with on-level pulses to scan signal lines. For example, the scan driver may be constructed in a form of a shift register and may generate a scan signal by sequentially transmitting a scan starting signal provided in a form of an on-level pulse to a next stage circuit under control of the clock signal.

In an exemplary embodiment, the light emitting driver may generate an emission signal to be provided to a light emitting signal line by receiving the clock signal, the light emitting stop signal, and the like from the timing controller. For example, the light emitting driver may provide emission signals with off-level pulses to the light emitting signal lines sequentially. For example, the light emitting driver may be constructed in a form of the shift register, and generate an emission signal by sequentially transmitting an emission stopping signal provided in the form of an off-level pulse to a next-stage circuit under the control of the clock signal.

In an exemplary embodiment, the display substrate may include a plurality of pixel units P arranged in a matrix, at least one of the multiple pixel units P includes a first sub-pixel emitting light of a first color, a second sub-pixel emitting light of a second color, and a third sub-pixel emitting light of a third color. The first sub-pixel, the second sub-pixel, and the third sub-pixel each include a pixel driving circuit and a light emitting device. Pixel driving circuits in the first sub-pixel, the second sub-pixel, and the third sub-pixel are connected with a scan signal line, a data signal line, and a light emitting signal line respectively. A pixel driving circuit is configured to receive a data voltage transmitted by the data signal line under control of the scan signal line and the light emitting signal line, and output a corresponding current to the light emitting device. The light emitting devices in the first sub-pixel, the second sub-pixel and the third sub-pixel are respectively connected to the pixel driving circuits of the sub-pixels where the light emitting devices are located. The light emitting device is configured to emit light of corresponding brightness in response to a current output by the pixel driving circuit of the sub-pixel where the light emitting device is located.

In an exemplary embodiment, the first sub-pixel may be a red (R) sub-pixel emitting red light, the second sub-pixel may be a blue (B) sub-pixel emitting blue light, and the third sub-pixel may be a green (G) sub-pixel emitting green light. In exemplary embodiments, the sub-pixel may have a shape of a rectangle, a rhombus, a pentagon, or a hexagon.

In an exemplary implementation, a pixel unit may include three sub-pixels, and the three sub-pixels may be arranged side by side horizontally, side by side vertically, or in a manner like a Chinese character “de”, which is not limited here in the present disclosure.

In an exemplary embodiment, a pixel unit may include four sub-pixels, and the four sub-pixels may be arranged in a manner to stand side by side horizontally, in a manner to stand side by side vertically, or in a manner to form a square, which is not limited here in the present disclosure.

In a plane perpendicular to the display substrate, the display panel may include a drive structure layer arranged on the base substrate, a light emitting structure layer arranged on one side of the drive structure layer away from the base substrate, and an encapsulation structure layer arranged on one side of the light emitting structure layer away from the base substrate. In some possible embodiments, the display substrate may include another film layer, such as a touch structure layer, which is not limited here in the present disclosure.

In exemplary embodiment, the base substrate may be a rigid substrate or a flexible substrate, wherein the rigid substrate may be, but is not limited to, one or more of glass and conductive foil. The flexible substrate may be, but is not limited to, one or more of polyethylene terephthalate, ethylene terephthalate, polyether ether ketone, polystyrene, polycarbonate, polyarylate, polyarylester, polyimide, polyvinyl chloride, polyethylene, and textile fiber.

In an exemplary embodiment, the driving structure layer may include a plurality of transistors and a storage capacitor forming a pixel driving circuit, and the light emitting structure layer may include an anode, a pixel definition layer, an organic light emitting layer, and a cathode, the anode is connected to a drain electrode of the transistor therein through a via, the organic light emitting layer is connected to the anode, and the cathode is connected to the organic light emitting layer, and the organic light emitting layer emits light of corresponding color under drive of the anode and the cathode.

In an exemplary embodiment, the encapsulation structure layer may include a first encapsulation layer, a second encapsulation layer, and a third encapsulation layer that are stacked. The first encapsulation layer and the third encapsulation layer may be made of an inorganic material, and the second encapsulation layer may be made of an organic material. The second encapsulation layer is provided between the first encapsulation layer and the third encapsulation layer, and it may be ensured that external water vapor cannot enter the light emitting structure layer.

In an exemplary embodiment, the touch structure layer may include a first touch insulating layer disposed on the encapsulation structure layer, a first touch metal layer disposed on the first touch insulating layer, a second touch insulating layer covering the first touch metal layer, a second touch metal layer disposed on the second touch insulating layer, and a touch protective layer covering the second touch metal layer, the first touch metal layer may include a plurality of bridge electrodes, the second touch metal layer may include a plurality of first touch electrodes and second touch electrodes, and the first touch electrodes or second touch electrodes may be connected to the bridge electrodes through vias.

In an exemplary implementation, the display apparatus may be any product or component with a display function, such as a mobile phone, a tablet computer, a television, a display, a laptop computer, a digital photo frame, or a navigator, and the embodiments of the present invention are not limited thereto.

The drawings of the embodiments of the present disclosure only involve structures involved in the embodiments of the present disclosure, and other structures may refer to a general design.

For the sake of clarity, a thickness and size of a layer or a micro structure are enlarged in the accompanying drawings used for describing the embodiments of the present disclosure. It may be understood that when an element such as a layer, film, region, or substrate is described as being “on” or “under” another element, the element may be “directly” located “on” or “under” the another element, or there may be an intermediate element.

Although the implementations of the present disclosure are disclosed above, the contents are only implementations used for ease of understanding of the present disclosure and not intended to limit the present disclosure. Any of those skilled in the art of the present disclosure can make any modifications and variations in the embodiment and details without departing from the spirit and scope of the present disclosure. However, the protection scope of the present disclosure should be subject to the scope defined by the appended claims.

1. A pixel driving circuit, comprising: a driving sub-circuit, a first control sub-circuit, a second control sub-circuit, a third control sub-circuit, and a storage sub-circuit, wherein:
the driving sub-circuit is electrically connected with a first node, a second node, and a third node respectively, and is configured to provide driving current for the third node under control of signals of the first node and the second node;
the first control sub-circuit is electrically connected with a first scan signal line, a second scan signal line, a data signal line, a reference signal line and the first node, respectively, and is configured to provide a signal of the data signal line or the reference signal line to the first node under control of signals of the first scan signal line and the second scan signal line;
the second control sub-circuit is electrically connected with a first light emitting signal line, a second light emitting signal line, a first power supply line, the second node, the third node and a fourth node, respectively, and is configured to provide a signal of the first power supply line to the second node and provide a signal of the third node to the fourth node under control of signals of the first light emitting signal line and the second light emitting signal line;
the third control sub-circuit is electrically connected with a first reset signal line, an auxiliary signal line and the third node, respectively, and is configured to control the signal of the third node under control of a signal of the first reset signal line and under drive of a signal of the auxiliary signal line; and
the storage sub-circuit is electrically connected with the first node and the third node, respectively, is configured to store a voltage difference of signals between the first node and the third node.

2. The pixel driving circuit according to claim 1, wherein: the third control sub-circuit comprises: a sixth transistor and a second capacitor;
a control electrode of the sixth transistor is electrically connected with the first reset signal line, a first electrode of the sixth transistor is electrically connected with the auxiliary signal line, and a second electrode of the sixth transistor is electrically connected with a fifth node; and
a first terminal of the second capacitor is electrically connected with the fifth node, and a second terminal of the second capacitor is electrically connected with the third node.

3. The pixel driving circuit according to claim 2, wherein the third control sub-circuit is further electrically connected with a third reset signal line and an initial signal line, respectively, and is configured to provide a signal of the initial signal line to the fourth node under control of a signal of the third reset signal line.

4. The pixel driving circuit according to claim 3, wherein: the third control sub-circuit further comprises: an eighth transistor, a control electrode of the eighth transistor is electrically connected with the third reset signal line, a first electrode of the eighth transistor is electrically connected with the initial signal line, and a second electrode of the eighth transistor is electrically connected with the fourth node; and
the signal of the auxiliary signal line is a non-Direct Current (DC) signal and is electrically connected with the fourth node.

5. The pixel driving circuit according to claim 1, wherein the third control sub-circuit is further electrically connected with a second reset signal line, is further configured to provide a signal of a fifth node to the third node under control of a signal of the second reset signal line.

6. The pixel driving circuit according to claim 5, wherein: the third control sub-circuit comprises: a sixth transistor, a seventh transistor, and a second capacitor;
a control electrode of the sixth transistor is electrically connected with the first reset signal line, a first electrode of the sixth transistor is electrically connected with the auxiliary signal line, and a second electrode of the sixth transistor is electrically connected with the fifth node;
a control electrode of the seventh transistor is electrically connected with the second reset signal line, a first electrode of the seventh transistor is electrically connected with the fifth node, and a second electrode of the seventh transistor is electrically connected with the third node; and
a first terminal of the second capacitor is electrically connected with the fifth node, and a second terminal of the second capacitor is electrically connected with the third node.

7. The pixel driving circuit according to claim 6, wherein the signal of the auxiliary signal line is a DC signal and is the same as a signal of any one of the initial signal line, the reference signal line and the first power supply line.

8. The pixel driving circuit according to claim 2, wherein: the third control sub-circuit comprises: a sixth transistor and a second capacitor;
a first terminal of the second capacitor is electrically connected with the auxiliary signal line, and a second terminal of the second capacitor is electrically connected with the fifth node; and
a control electrode of the sixth transistor is electrically connected with the first reset signal line, a first electrode of the sixth transistor is electrically connected with the fifth node, and a second electrode of the sixth transistor is electrically connected with the third node.

9. The pixel driving circuit according to claim 6- or 8, wherein the third control sub-circuit is further electrically connected with the third reset signal line and the initial signal line, respectively, and is configured to provide a signal of the initial signal line to the fourth node under control of a signal of the third reset signal line.

10. The pixel driving circuit according to claim 9, wherein: the third control sub-circuit further comprises: an eighth transistor, a control electrode of the eighth transistor is electrically connected with the third reset signal line, a first electrode of the eighth transistor is electrically connected with the initial signal line, and a second electrode of the eighth transistor is electrically connected with the fourth node; and
a signal of the auxiliary signal line is a DC signal, and the signal of the auxiliary signal line is the same as a signal of any one of the initial signal line, the reference signal line and the first power supply line; or
the signal of the auxiliary signal line is a non-DC signal, and the signal of the auxiliary signal line is electrically connected with the fourth node.

11. The pixel driving circuit according to claim 1, wherein: the first control sub-circuit comprises: a first transistor and a second transistor, the driving sub-circuit comprises:
a third transistor, the second control sub-circuit comprises: a fourth transistor and a fifth transistor, and the storage sub-circuit comprises: a first capacitor;
a control electrode of the first transistor is electrically connected with the first scan signal line, a first electrode of the first transistor is electrically connected with the data signal line, and a second electrode of the first transistor is electrically connected with the first node;
a control electrode of the second transistor is electrically connected with the second scan signal line, a first electrode of the second transistor is electrically connected with the reference signal line, and a second electrode of the second transistor is electrically connected with the first node;
a control electrode of the third transistor is electrically connected with the first node, a first electrode of the third transistor is electrically connected with the second node, and a second electrode of the third transistor is electrically connected with the third node;
a control electrode of the fourth transistor is electrically connected with the first light emitting signal line, a first electrode of the fourth transistor is electrically connected with the first power supply line, and a second electrode of the fourth transistor is electrically connected with the second node;
a control electrode of the fifth transistor is electrically connected with the second light emitting signal line, a first electrode of the fifth transistor is electrically connected with the third node, and a second electrode of the fifth transistor is electrically connected with the fourth node; and
a first terminal of the first capacitor is electrically connected with the first node, and a second terminal of the first capacitor is electrically connected with the third node.

12. The pixel driving circuit according to claim 1, wherein: the first control sub-circuit comprises: a first transistor and a second transistor, the driving sub-circuit comprises: a third transistor, the second control sub-circuit comprises: a fourth transistor and a fifth transistor, the storage sub-circuit comprises: a first capacitor, the third control sub-circuit comprises a second capacitor and a sixth transistor, and the third control sub-circuit further comprises: at least one of a seventh transistor and an eighth transistor;
a control electrode of the first transistor is electrically connected with the first scan signal line, a first electrode of the first transistor is electrically connected with the data signal line, and a second electrode of the first transistor is electrically connected with the first node;
a control electrode of the second transistor is electrically connected with the second scan signal line, a first electrode of the second transistor is electrically connected with the reference signal line, and a second electrode of the second transistor is electrically connected with the first node;
a control electrode of the third transistor is electrically connected with the first node, a first electrode of the third transistor is electrically connected with the second node, and a second electrode of the third transistor is electrically connected with the third node;
a control electrode of the fourth transistor is electrically connected with the first light emitting signal line, a first electrode of the fourth transistor is electrically connected with the first power supply line, and a second electrode of the fourth transistor is electrically connected with the second node;
a control electrode of the fifth transistor is electrically connected with the second light emitting signal line, a first electrode of the fifth transistor is electrically connected with the third node, and a second electrode of the fifth transistor is electrically connected with the fourth node;
a control electrode of the sixth transistor is electrically connected with the first reset signal line, a first electrode of the sixth transistor is electrically connected with the auxiliary signal line, and a second electrode of the sixth transistor is electrically connected with a fifth node;
a control electrode of the seventh transistor is electrically connected with a second reset signal line, a first electrode of the seventh transistor is electrically connected with the fifth node, and a second electrode of the seventh transistor is electrically connected with the third node;
a control electrode of the eighth transistor is electrically connected with a third reset signal line, a first electrode of the eighth transistor is electrically connected with an initial signal line, and a second electrode of the eighth transistor is electrically connected with the fourth node;
a first terminal of the first capacitor is electrically connected with the first node, and a second terminal of the first capacitor is electrically connected with the third node;
a first terminal of the second capacitor is electrically connected with the fifth node, and a second terminal of the second capacitor is electrically connected with the third node; and
any one of the first transistor to the eighth transistor is an N-type transistor.

13. The pixel driving circuit according to claim 12, wherein: the third control sub-circuit comprises the sixth transistor, the seventh transistor, and the second capacitor; and
signals of the second reset signal line and the second light emitting signal line are effective level signals during part of a time period in which the signal of the first reset signal line is an effective level signal, and the signal of the second reset signal line is an effective level signal during at least part of a time period after a writing time period, the writing time period is a time period in which a signal of the first scan signal line is an effective level signal.

14. The pixel driving circuit according to claim 12, wherein: the third control sub-circuit comprises the sixth transistor, the eighth transistor, and the second capacitor; and
a signal of the second light emitting signal line is an effective level signal during part of a time period in which a signal of the third reset signal line is an effective level signal, and signals of the first reset signal line and the second light emitting signal line are effective level signals during at least part of a time period after a writing time period, the writing time period is a time period in which a signal of the first scan signal line is an effective level signal.

15. The pixel driving circuit according to claim 12, wherein: the third control sub-circuit comprises the sixth transistor, the seventh transistor, the eighth transistor, and the second capacitor; and
in a case that a signal of the first reset signal line is an effective level signal, a signal of the third reset signal line is an effective level signal, and a signal of the second reset signal line is an ineffective level signal, in a case that the signal of the second reset signal line is an effective level signal, the signal of the first reset signal line is an ineffective level signal, a signal of the second light emitting signal line is an effective level signal during part of a time period in which the signal of the third reset signal line is an effective level signal, and the signal of the second reset signal line is an effective level signal during at least part of a time period after a writing time period, and the writing time period is a time period in which a signal of the first scanning signal line is an effective level signal.

16. The pixel driving circuit according to claim 1, wherein: the first control sub-circuit comprises: a first transistor and a second transistor, the driving sub-circuit comprises: a third transistor, the second control sub-circuit comprises: a fourth transistor and a fifth transistor, and the storage sub-circuit comprises: a first capacitor, the third control sub-circuit comprises: a second capacitor, a sixth transistor, and an eighth transistor;
a control electrode of the first transistor is electrically connected with the first scan signal line, a first electrode of the first transistor is electrically connected with the data signal line, and a second electrode of the first transistor is electrically connected with the first node;
a control electrode of the second transistor is electrically connected with the second scan signal line, a first electrode of the second transistor is electrically connected with the reference signal line, and a second electrode of the second transistor is electrically connected with the first node;
a control electrode of the third transistor is electrically connected with the first node, a first electrode of the third transistor is electrically connected with the second node, and a second electrode of the third transistor is electrically connected with the third node;
a control electrode of the fourth transistor is electrically connected with the first light emitting signal line, a first electrode of the fourth transistor is electrically connected with the first power supply line, and a second electrode of the fourth transistor is electrically connected with the second node;
a control electrode of the fifth transistor is electrically connected with the second light emitting signal line, a first electrode of the fifth transistor is electrically connected with the third node, and a second electrode of the fifth transistor is electrically connected with the fourth node;
a control electrode of the sixth transistor is electrically connected with the first reset signal line, a first electrode of the sixth transistor is electrically connected with a fifth node, and a second electrode of the sixth transistor is electrically connected with the third node;
a control electrode of the eighth transistor is electrically connected with a third reset signal line, a first electrode of the eighth transistor is electrically connected with an initial signal line, and a second electrode of the eighth transistor is electrically connected with the fourth node;
a first terminal of the first capacitor is electrically connected with the first node, and a second terminal of the first capacitor is electrically connected with the third node;
a first terminal of the second capacitor is electrically connected with the auxiliary signal line, and a second terminal of the second capacitor is electrically connected with the fifth node; and
any one of the first transistor, the second transistor, the fourth transistor, the fifth transistor, the sixth transistor, and the eighth transistor is an N-type transistor.

17. The pixel driving circuit according to claim 16, wherein a signal of the second light emitting signal line is an effective level signal during part of a time period in which a signal of the third reset signal line is an effective level signal, and a signal of the first reset signal line is an ineffective level signal during a time period after a writing time period, the writing time period is a time period in which a signal of the first scanning signal line is an effective level signal.

18. A display apparatus with a display region, wherein the display region is provided with a plurality of pixel driving circuits according to claim 1.

19. A driving method for a pixel driving circuit, configured to drive the pixel driving circuit according to claim 1, the method comprising:
providing, by the driving sub-circuit, driving current to the third node under control of signals of the first node and the second node;
providing, by the first control sub-circuit, the signal of the data signal line or the reference signal line to the first node under control of signals of the first scan signal line and the second scan signal line;
providing, by the second control sub-circuit, the signal of the first power supply line to the second node and the signal of the third node to the fourth node under control of signals of the first light emitting signal line and the second light emitting signal line;
controlling, by the third control sub-circuit, the signal of the third node under control of the signal of the first reset signal line and under drive of the signal of the auxiliary signal line; and
storing, by the storage sub-circuit, the voltage difference of the signals between the first node and the third node.

20. A driving method for a pixel driving circuit, configured to drive the pixel driving circuit according to claim 13, wherein a working process of the pixel driving circuit comprises a first stage to a fifth stage, the method comprising:
in the first stage, providing effective level signals to signals of the second scan signal line, the second light emitting signal line, the first reset signal line and the second reset signal line, providing, by the first control sub-circuit, a signal of the reference signal line to the first node, providing, by the third control sub-circuit, a signal of the auxiliary signal line to the fifth node, and a signal of the fifth node to the third node, and providing, by the second control sub-circuit, a signal of the fourth node to the third node;
in the second stage, providing effective level signals to the first reset signal line, the second scan signal line and the first light emitting signal line, providing, by the first control sub-circuit, the signal of the reference signal line to the first node, providing, by the third control sub-circuit, the signal of the auxiliary signal line to the fifth node, providing, by the second control sub-circuit, a signal of the first power supply line to the second node to charge the first node, and storing, by the storage sub-circuit a voltage difference between signals of the first node and the third node;
in the third stage, signals to the first reset signal line and the first scan signal line are high-level signals, providing, by the first control sub-circuit, the signal of the data signal line to the first node, and providing, by the third control sub-circuit, the signal of the auxiliary signal line to the fifth node;
in the fourth stage, providing effective level signals to the second reset signal line and the second light emitting signal line, providing, by the third control sub-circuit, the signal of the third node to the fifth node, and providing, by the second control sub-circuit, the signal of the fourth node to the third node; and
in the fifth stage, providing effective level signals to the second reset signal line, the first light emitting signal line and the second light emitting signal line, providing, by the second control sub-circuit, the signal of the first power supply line to the second node, the signal of the third node to the fourth node, providing, by the driving sub-circuit, driving current to the third node under control of signals of the first node and the second node, and providing, by the third control sub-circuit, the signal of the third node to the fifth node.

21-23. (canceled)
